(19) United States
(12) Patent Application Publication
(10) Pub. No.: US 2014/0075093 A1
(43) Pub. Date: Mar. 13, 2014

(54) METHOD AND SYSTEM FOR IMPLICIT OR EXPLICIT ONLINE REPAIR OF MEMORY

(71) Applicants: Robert Wiesner, Bad Aibling (DE); Rudolf Ullmann, Seefeld (DE); Walter Mischo, Muenchen (DE); Jens Rosenbusch, Muenchen (DE)

(72) Inventors: Robert Wiesner, Bad Aibling (DE); Rudolf Ullmann, Seefeld (DE); Walter Mischo, Muenchen (DE); Jens Rosenbusch, Muenchen (DE)

(73) Assignee: Infineon Technologies AG, Neubiberg (DE)

(21) Appl. No.: 13/612,097

(22) Filed: Sep. 12, 2012

(51) Int. Cl. G06F 12/02

(52) U.S. Cl. CPC G06F 12/02
USPC 711/103

(57) ABSTRACT

Systems and methods related to a memory device are provided. The systems and methods include using at least one driver with predetermined reduced driving capability to drive at least one of the memory elements of the memory device in a reliable detection algorithm. The at least one driver has reduced driving capability compared to a driver used for standard read access. The reliable detection algorithm can include detecting failing memory elements on a respective reading current diverging from an expected or expectable reading current.

### FIELD

The present invention relates generally to methods and systems for online repair and secure content verify of memory, and, in particular of nonvolatile memory (NVM) such as flash memory, for example embedded in microcontrollers.

### BACKGROUND

Semiconductor memories, here especially flash memories embedded in microcontrollers, suffer from a defect density related field failure rate due to activation of latent defects causing full wordline and/or bitline failures. Corresponding memory failures often occur in automotive applications either at code or data down-load or update time in the context of programming or erasing the respective memory. More generally speaking, the memory failures occur due to high and medium voltage exposure of the latent defects circuits at wordline or bitline (cells, driver circuits) during the programming or erasing. In case of a flash memory embedded in a microcontroller of an electronic control circuit (ECU), the memory failures may appear after assembly of the microcontroller into the ECU in an end of line testing or flashing of the embedded code flash of the ECU or in an data flash EEPROM emulation operation in the field. In this context, it may be noted that some latent defects at high voltage (HV) global or local bitline switching circuits may even be activated to fail at read time.

State of the art semiconductor memories apply redundancy repair in wafer sort or device test in order to preserve manufacturing yield even in case of unavoidable technology defect density by replacing electrically detectable defects in singular or clustered memory cells, wordlines or bitlines or blocks by mapping respective redundant elements. Depending on circuit implementation, repair unloads at least partially respective defects at wordlines or bitlines from the high voltage exposure and therefore prevents or reduces further degradation of replaced defect memory elements, preventing follow-up malfunctions at used memory elements. In wafer sort and device burning, elevated erase and program voltage stress or temperature stress is used to activate the latent defects in manufacturing test environment in order to see prevent field or end of line activation.

The above-mentioned memory latent failures cannot always be sufficiently identified by device stressing or screening in electrical device sort and/or prevented by technological defect density reduction screening or by “repair containments” (e.g. scrapping devices rather than using non-sustainable repair). Note that all repair containments, e.g. also the activation of bitline and wordline redundancy for every singular cell memory weak cell failure to prevent further stress, may only be successful, if a single cell weak fail is already detectable in the latent state, i.e. before field stress activation. State of the art semiconductor memory devices provide electrical error correction (ECC) and detection means. Note that these means can correct and detect only a restricted number of bits per data word read at runtime (e.g. SECDED single bit error correction, double bit error detection) and therefore can compensate typically singular cell e.g. retention fails and bitline oriented fails, but not wordline or block fails.

### SUMMARY

A method and system for implicit or explicit online repair of memory is provided, substantially as shown in and/or described in connection with at least one of the figures, as set forth more completely in the claims.

Further features and advantages of embodiments will become apparent from the following detailed description made with reference to the accompanying drawings.

### BRIEF DESCRIPTION OF THE DRAWINGS

The accompanying drawings are included to provide a further understanding and are incorporated in and constitute a part of this specification. The drawings relate to examples and embodiments and together with the description serve to explain the principles of the invention. Other embodiments and many of the intended advantages of embodiments will be readily appreciated as they become better understood by reference to the following detailed description.

FIG. 1a shows a flow chart of an over erase algorithm (OEA) with online repair extensions according to a variant of a first embodiment;

FIG. 1ba shows a schematical diagram of a memory device with 2 pages of 128 bytes per wordline in an over erase algorithm after a “program all” sub step and before a physical erase step according to the variant of the first embodiment (explicit online-repair);

FIG. 1bb shows a schematical diagram of the memory device in the over erase algorithm according to FIG. 1ba after a first physical erase step according to the variant of the first embodiment;

FIG. 1bc shows a schematical diagram of the memory device in the over erase algorithm according to FIG. 1bb after a second physical erase step according to the variant of the first embodiment;

FIG. 1bd shows a schematical diagram of the memory device in the over erase algorithm according to FIG. 1bc after a third physical erase step according to the variant of the first embodiment;

FIG. 1be shows a schematical diagram of the memory device in the over erase algorithm according to FIG. 1bd after a fourth physical erase step according to the variant of the first embodiment;

FIG. 1bf shows a schematical diagram of the memory device in the over erase algorithm according to FIG. 1be after a fifth physical erase step according to the variant of the first embodiment;

FIG. 1ca shows a schematical diagram of a memory device with 2 pages of 128 bytes per wordline in an over erase algorithm after a “program all” step, an optional “program verify” or “expect all 1” step to detect a defect bitline and before a physical erase step according to the variant of the first embodiment;

FIG. 1cb shows a schematical diagram of the memory device in the over erase algorithm according to FIG. 1ca after a first verify step before a physical erase step and a “erase verify” or “expect all 0” step according to the variant of the first embodiment;

FIG. 1cc shows a schematical diagram of the memory device in the over erase algorithm according to FIG. 1cb after a first physical erase step according to the variant of the first embodiment;

FIG. 1cd shows a schematical diagram of the memory device in the over erase algorithm according to FIG. 1cc after a second physical erase step according to the variant of the first embodiment;

FIG. 1ce shows a schematical diagram of the memory device in the over erase algorithm according to FIG. 1cd after a third physical erase step according to the variant of the first embodiment;

FIG. 1cf shows a schematical diagram of the memory device in the over erase algorithm according to FIG. 1ce after a fourth physical erase step according to the variant of the first embodiment;

FIG. 1cg shows a schematical diagram of the memory device in the over erase algorithm according to FIG. 1cf after a fifth physical erase step according to the variant of the first embodiment;

FIG. 1ch shows a schematical diagram of the memory device in the over erase algorithm according to FIG. 1cg after an erase re-verify step after an online repair step according to the variant of the first embodiment;

FIG. 2a shows a flow chart of a progressive erase algorithm (PEM) with online repair extensions according to a further variant of the first embodiment;

FIG. 2ba shows a schematical diagram of a memory device with 64 pages of 8 bytes per wordline in the progressive erase algorithm after a forming bias step and before a physical “erase all” step according to the further variant of the first embodiment;

FIG. 2bb shows a schematical diagram of the memory device in the progressive erase algorithm according to FIG. 2ba after a first physical erase step according to the further variant of the first embodiment;

FIG. 2bc shows a schematical diagram of the memory device in the progressive erase algorithm according to FIG. 2bb after a second physical erase step according to the further variant of the first embodiment;

FIG. 2bd shows a schematical diagram of the memory device in the progressive erase algorithm according to FIG. 2bc after a third physical erase step according to the further variant of the first embodiment;

FIG. 2be shows a schematical diagram of the memory device in the progressive erase algorithm according to FIG. 2bd after a fourth physical erase step according to the further variant of the first embodiment;

FIG. 2bf shows a schematical diagram of the memory device in the progressive erase algorithm according to FIG. 2be after a fifth physical erase step according to the further variant of the first embodiment;

FIG. 2ca shows a schematical diagram of a memory device with 64 pages of 8 bytes per wordline in the progressive erase algorithm after a forming bias step before a physical “erase all” step according to the further variant of the first embodiment;

FIG. 2cb shows a schematical diagram of the memory device in the progressive erase algorithm according to FIG. 2ca after a first physical erase step and forming bias step according to the further variant of the first embodiment;

FIG. 2cc shows a schematical diagram of the memory device in the progressive erase algorithm according to FIG. 2cb after a second physical erase step and forming bias step according to the further variant of the first embodiment;

FIG. 2cd shows a schematical diagram of the memory device in the progressive erase algorithm according to FIG. 2cc after a third physical erase step and forming bias step according to the further variant of the first embodiment;

FIG. 2ce shows a schematical diagram of the memory device in the progressive erase algorithm according to FIG. 2cd after an erase re-verify step after an online repair step according to the further variant of the first embodiment;

FIG. 2cf shows a schematical diagram of the memory device in the progressive erase algorithm according to FIG. 2ce after a fourth physical erase step and forming bias step according to the further variant of the first embodiment;

FIG. 3 shows a schematical overview of addressing memory elements of a memory field via a MapRAM table in the address path according to a variant of a second embodiment (implicit online-repair);

FIG. 4 shows a schematical overview of addressing memory elements of a memory field via a MapRAM table and a redundancy bank in the address path according to a still further variant of the second embodiment;

FIG. 5 shows a mapping table and a corresponding table of nonvolatile memory pages to illustrate a mapping algorithm according to a variant of the second embodiment starting with a linear mapping between logical and physical memory pages;

FIG. 6 illustrates the mapping algorithm according to the variant of the second embodiment of FIG. 5 after copying logical memory page 4 to an assembly buffer (AB);

FIG. 7 illustrates the mapping algorithm according to the variant of the second embodiment of FIG. 6 after changing the assembly buffer;

FIG. 8 illustrates the mapping algorithm according to the variant of the second embodiment of FIG. 7 after writing to the first spare logical memory page;

FIG. 9 illustrates the mapping algorithm according to the variant of the second embodiment of FIG. 8 after erasing logical memory page 4;

FIG. 10 illustrates the mapping algorithm according to the variant of the second embodiment of FIG. 9 after updating the mapping table;

FIG. 11 illustrates the mapping algorithm according to the variant of the second embodiment of FIG. 10 after copying logical memory page 1 to the assembly buffer;

FIG. 12 illustrates the mapping algorithm according to the variant of the second embodiment of FIG. 11 after changing the assembly buffer again;

FIG. 13 illustrates the mapping algorithm according to the variant of the second embodiment of FIG. 12 after writing to the first spare logical memory page again;

FIG. 14 illustrates the mapping algorithm according to the variant of the second embodiment of FIG. 13 after erasing logical memory page 1;

FIG. 15 illustrates the mapping algorithm according to the variant of the second embodiment of FIG. 14 after updating the mapping table again;

FIG. 16 illustrates the mapping algorithm according to the variant of the second embodiment of FIG. 5 after 23 programming steps;

FIG. 17 illustrates the mapping algorithm according to the variant of the second embodiment of FIG. 16 in a read access to logical memory page 4;

FIG. 18 illustrates the mapping algorithm according to the variant of the second embodiment of FIG. 13 wherein the writing to the first spare logical memory page is unsuccessful and the content of the assembly buffer is also written to a second spare logical memory page;

FIG. 19 illustrates the mapping algorithm according to the variant of the second embodiment of FIG. 18 after updating the mapping table;

FIG. 20 illustrates the mapping algorithm according to the variant of the second embodiment of FIG. 15 wherein the erasing of physical memory page 1 is unsuccessful and the content of the assembly buffer is also written to a second spare logical memory page; and

FIG. 21 illustrates the mapping algorithm according to the variant of the second embodiment of FIG. 20 after erasing physical memory page 4 instead of the inerasable physical memory page 1 and updating the mapping table.

### DETAILED DESCRIPTION

In the following detailed description, reference is made to the accompanying drawings, which form a part hereof, and in which are shown by way of illustration specific embodiments. It is to be understood that other embodiments may be utilized and structural or other changes may be made without departing from the scope of the present invention. The following detailed description, therefore, is not to be taken in a limiting sense, and the scope of the present invention is defined by the appended claims.

In the following, for illustration purposes, the invention will be described with reference to embedded flash memory. However, the invention is not limited and may find its application in conjunction with any other type of online repair or fault detection for memory.

In the following, the term weak shorts affecting a wordline of a memory shall be differentiated from hard shorts. In the case of hard shorts, the wordline content of the correspondingly shortened wordline may often read the value that corresponds to no cell current due to a non-selectable wordline shorted to the bitline, so here e.g. all logical ones. In case of weaker shorts of the wordline however, the wordline may be no longer programmable or erasable. As a result, a constant—previously programmed or transient—content may appear “frozen” during read as high voltage pumps during program and erase cannot provide enough current to rise wordline voltages to required levels.

As mentioned before, the detection of such weaker shorts appears critical. In this regard, a detection of a shorted wordline in a read mode alone by comparing the result of read access via a weak wordline driver with the result of a standard read access—while not knowing that the wordline can be expected to be erased—may be error prone. An example case for the susceptibility to errors in the detection of memory failures by a read mode alone is the case when the wordline is in fact hard shorted.

Hence, a standard tearing safe (i.e. power failure safe) programming algorithm is an EEPROM emulation in the memory wherein the so called MapRAM may support the logical to physical mapping of word data. The MapRAM may hold the administrative information of all pages of a sector of the memory which allows for a consistent mapping of logical to physical memory pages. Furthermore, it is noted that the terminology “tearing” stems from the chip card world, where an interrupted power supply due to a chip card being “torn” out of reader forms part of a normal operation.

Such a standard tearing safe programming algorithm—even if extended by verify read backs—may not detect and resolve memory failures during power up by the corresponding service algorithm correctly when the memory is affected by permanent wordline failures. I.e. invalid or inconsistent data and inconsistent mapping info may persist in such cases as an erase process may not be able to change the state of the wordline anymore.

When occurring in the field, bitline induced failures are usually online corrected by single error correct double error detect (e.g. SECDED) type error correction codes (ECC), whereas wordline short related failures may result in content deviation of full data words and therefore device functional failures (content deviation) even after ECC correction. Accordingly, it is necessary that wordline short related failures are handled by repair strategies.

On the one hand, pure ECC based correction of bitline induced failures has the advantage of immediate effectiveness. This becomes evident by the fact that—for example—no corrective erase or reprogramming actions need to be taken. The erase or reprogramming actions may reduce the effectiveness of error correction as they might open again fail corner scenarios like power-induced operation interruption or any permanent fail or memory corruption due to temporal out of specification execution of code at update time, i.e. the so-called corrupted code execution risk.

However, the risk for a fail of correction by ECC is significantly elevated in case a stuck-at fault bitline is present. In that case, any single bit error (SBE)—such as for example a cycling induced moving bit or data retention bit—occurring in any of the affected words may then cause errors that are non-recoverable by ECC as well. Therefore, in previous solutions ECC capabilities needed further extension such as double bit error correction, triple bit error detection at expense of increased array size and access time penalty.

However, in order to recover from wordline oriented fails, a bad block management may be needed and may be provided by—for example—skipping of wordlines based on the above-mentioned EEPROM emulation. While with respect to the EEPROM emulation, customer software may handle memory allocation and bad block management by skipping wordlines in data flashes, for code flash this is usually not acceptable since CPU execution code may be linked or co-located.

Therefore, a “SMART” approach like in U.S. Pat. No. 8,010,847 with hardware-implemented bad block handling with unchanged target addresses for customer applications may be mandatory for code flashes. In this context, “SMART” is an acronym for SRAM Memory Automatic Repair Toolbox. According to “SMART”, additional redundant memory lines may be used to repair faulty memory lines by copying the content faulty memory lines into redundant lines dynamically during runtime.

In this case, the replacement of bad wordlines could be done by cache or SRAM blocks. However, the “run time” detection of a problem and the buffering before data is lost—since ECC may not re-determine the previous content then—as well as the final nonvolatile storage of endangered wordline content for a next power-up is then a challenging complex operation.

Any immediate real time correction or online repair in case of a failing programming operation is significant or critical. In this regard, the root cause of the failing programming operation—that could be both power down during programming (“tearing”) or a wordline short and programming—may usually be much more “throughput critical” such as during emergency programming.

Moreover, there is the above-mentioned risk of “corrupted code execution” in case of uncontrolled power down, for instance in the tearing case. I.e. unintended flash state machine operations may corrupt the overall storage data state when the supply voltage gradually leaves the specification window during an online repair capable programming operation without causing an immediate reset.

A tearing safe implementation of programming operation which incorporates an erase may cause significant timing overheads. Hence, all online-repair processing in a programming operation may significantly prolong the worst case programming cycle time, for instance by nonvolatile copying of full wordline buffer data to repairing wordlines.

According to a first embodiment, “true” explicit online repair algorithm of flash is ideally executed at the time of erasing a physical or logical sector. The online repair algorithm is understood as being implemented inside or nested into an over-erase type algorithm such as a NOR depletion recovery erase algorithm and or an adaptive erase algorithm wherein the memory is re-erased until a minim target erase threshold voltage V_{t,min} of its flash transistors is reached.

In this regard, state of the art smart erase algorithms apply erase verify steps in a predetermined way to critically examine a wordline or cell state using special verify modes to recognize wordline shorts or worn-out cells, for instance, in endurance clusters.

One way to reliably detect a weak short affecting a wordline is immediately after the wordline was erased using a read via a weak wordline driver path. Using a weak wordline driver high voltage path in erase verify read will make even “weak” shorts visible. A weak wordline driver is normally used for programming purposes. As such, the weak wordline driver is capable of applying high voltages to a wordline. However, the weak wordline driver called weak because of its weak or limited driving capabilities due to an elevated on-resistance.

Hence, to determine a weak short on a wordline using a weak wordline driver can be advantageous since a weak short on the wordline will cause that the weak wordline driver will not be able to drive the wordline to the same voltage level as in the case when no weak short affects the wordline. In contrast to that, the standard wordline driver used for read access purposes has better driving capabilities to quickly drive the wordline to a predetermined voltage via a reduced on resistance. As a result, if a wordline affected by a weak short is driven by the standard wordline driver used for read access with its better driving capabilities, the wordline might still reach the predetermined voltage such that the weak short might not be detectable due to an insufficient deviation from the target voltage the wordline is to be driven to. Then read operation might be distorted later at e.g., high temperature conditions.

In one embodiment, a memory sector may be erased or initialized in predetermined way, so less content consistency problems may arise. Unsuccessful erase operations or interrupted erase operations due to power breaks can easily be recovered by “re-do's”, i.e. by re-performing the corresponding erase operation. Moreover, impacts of the irregular erase operations to other sectors may be blocked by hardware when entering the erase algorithm.

According to one embodiment, replacement of failing memory—for instance as caused by a shorted wordline—is done by calculating and local NVM storage of a second list of redundancy elements to be considered at boot time for redundancy mapping. As a result, almost no boot delay is incurred. In one embodiment, the local NVM storage is located close to the sector which is to be repaired.

In embodiments, the hardware-implemented bad memory block handling algorithm based on the above-mentioned “SMART” technology is extended with two sets of redundancy elements. As a result, the extended “SMART” technology may effectively handle even cases of failing redundancy elements.

Consequently, the customer of the corresponding memory may be unloaded from error-prone bad block treatments by conventional EEPROM emulation algorithms. Furthermore, corresponding embodiments are advantageous in that stress and fail risk may be reduced. For instance, according to some of the above-mentioned embodiments, wordlines are no longer set to high voltage after the repair operations. Moreover, charge pump failure due to overload may be less likely. In embodiments, customer application software may trace and enable or disable in-field additional redundancy activation and may react on a reduced safety level accordingly.

In an extended embodiment, any failure that is observed or temporally repaired at programming time—especially a defective bitline—may be finally resolved during the next erase operation with the above-mentioned online repair mechanism. However, in embodiments, a bitline repair may only be possible if the bitline redundancy mapping granularity matches the erase sector granularity.

In a further extended embodiment, especially a bitline failure detection and correction mechanism may also be part of the online failure detection steps in a corresponding erase algorithm. In this regard, a bitline failure due to a high voltage global-local switch failure—i.e. a failure in a switch that connects a global bitline to a local bitline—due to read stress may read all ones in an erased state and may be detected as deviations in erased state. In particular, if a complex erase algorithm applies a program all sub step—for example as a first step of a FN/FN (FowlerNordheim) depletion recovery algorithm—a shorted bitline can also be detected after a programming operation as deviation from the expected all ones state (“All-1”), added to a second list of bitline redundancy and be removed from stress voltage. In case of a short between wordline and bitline, the wordline often reads an all zero state (“All-0”) usually with exception to the short position between the wordline and the bitline.

The online repair mechanism according to the first embodiment is proposed especially for data flash wordlines. However, the online repair mechanism may also be implemented within code flash erase algorithms that use for example redundancy spare sectors as code flash type bad block treatment.

A second embodiment of an online repair mechanism (implicit online repair) uses a MapRAM-based EEPROM emulation algorithm. The principles of this second embodiment may be applicable to all types of page by page erase or program update EEPROM algorithms. In corresponding embodiments, erase and program should be executed with same granularity. Then, the online repair algorithm may not only be nested into the erase algorithm sub step only but also into the top level of the update—i.e. program, erase and remap—as well as the service algorithm. In embodiments, the erase sub step may still consist of the over-erase type, i.e. NOR depletion recovery erase, algorithm and or the above-mentioned adaptive erase algorithm.

According to the principles of the second embodiment, in case of persisting functional program and erase problems with a specific physical memory page, the corresponding logical memory page may be mapped to “static” spare pages—that have so far been used or proposed as a matter of wear leveling or endurance extension only. In the context of this application, the term memory page may refer to the memory elements that are addressable by a wordline or to a subset of these memory elements.

In variants of the second embodiment, detection of shorted wordlines may be enabled by adding non-trivial valid markers—such as e.g. Cyclic Redundancy Check (CRC)—to page content of tearing-safe MapRAM program or update algorithms. Moreover, shorted wordline detection may be enabled using the above-mentioned “verify erase” based on read access via the weak wordline driver path.

In embodiments, the CRC may check content of the whole storage wordline or page block. As a result, the online repair mechanism may be reduced to a kind of online-invalidation of available EEPROM static spare pages which represent the second set of replacements in the sense of the “SMART” technology in an implicit manner.

In embodiments, advantages as mentioned above may be achieved by using the corresponding algorithm. In particular, program or erase operations on defect area may be avoided. However, read operations may be avoided only in embodiments that use a wordline redundancy bank as in the embodiment of FIG. 4. Besides, in embodiments, a prolongation of program and boot time and some more risk of corrupted code execution corruptions may be avoided. Typically, bitline repair mechanisms inside the algorithm according to the second embodiment are not supported.

Generally, flash memory may suffer from intrinsic or extrinsic data retention type fail modes such as classical data retention, moving bit cycle or stress induced and read disturb. In memories with structure and gate lengths below 90 nm, more and more especially read bias induced cell current losses may occur in low threshold voltage state, an effect which depends on the read bias time (cf. SILC-type).

In embodiments, a “SMART” service algorithm may be activated to detect and correct tearing effects and therefore may also implicitly detect “refresh demand” of wordlines or pages during boot or read. Other embodiments, may comprise special check intervals and execute full or partial flash “refreshes” erase and re-program for example SRAM-buffered content.

In embodiments, “true” or explicit online repair of wordlines during a refresh-erase sub step—i.e. real wordline redundancy replacement by redundant wordlines or using the MapRAM algorithm to map memory pages to static repair pages instead of a refresh-type re-initialization (implicit online repair) only—may be considered as an additional and/or alternative measure instead of refresh for robust operation. This holds especially if refresh operations without repair operations turn out to be necessary at execution time frequently on certain memory areas as refresh intervals are becoming gradually shorter and shorter. Thus, in such cases, an erase counter may be a solution to avoid an excessive number of refresh operations. In this context it should be noted that frequent memory content cycling as done by refresh operations gradually worsens charge loss phenomena such as for example affecting a moving bit failure mode.

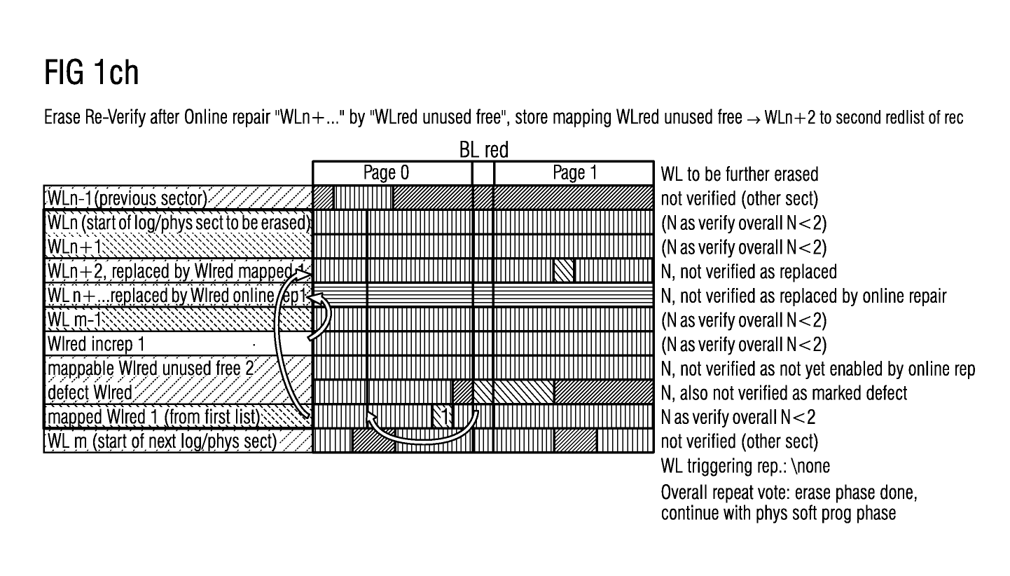

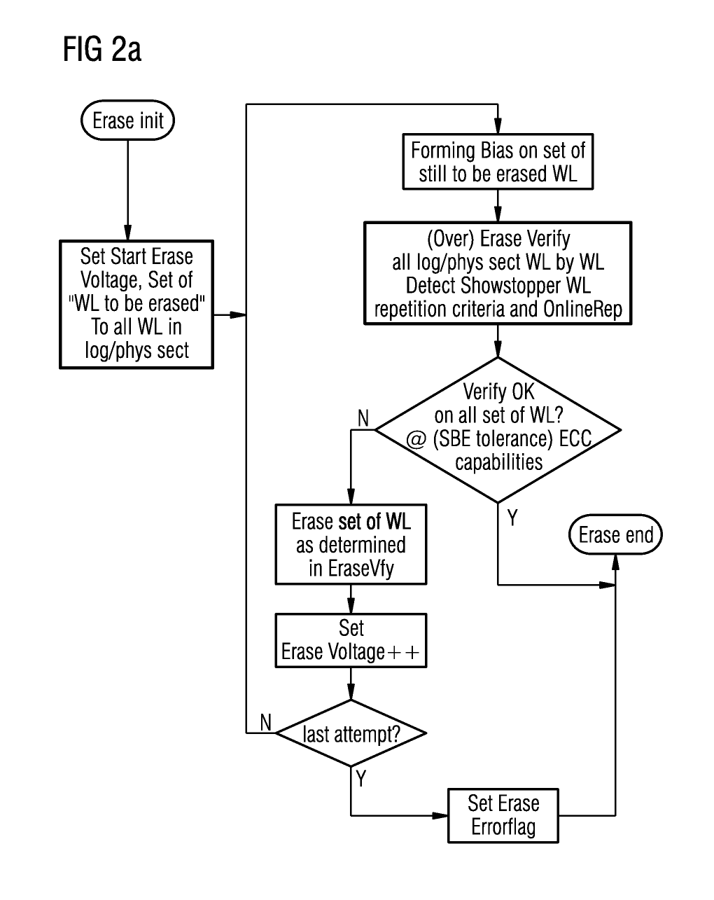

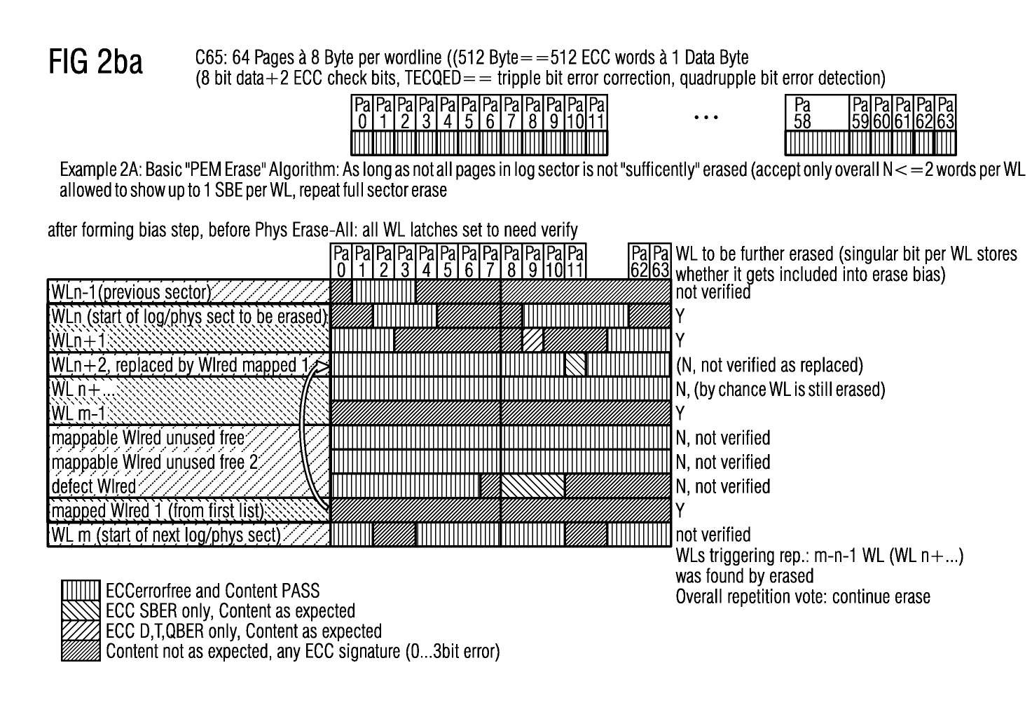

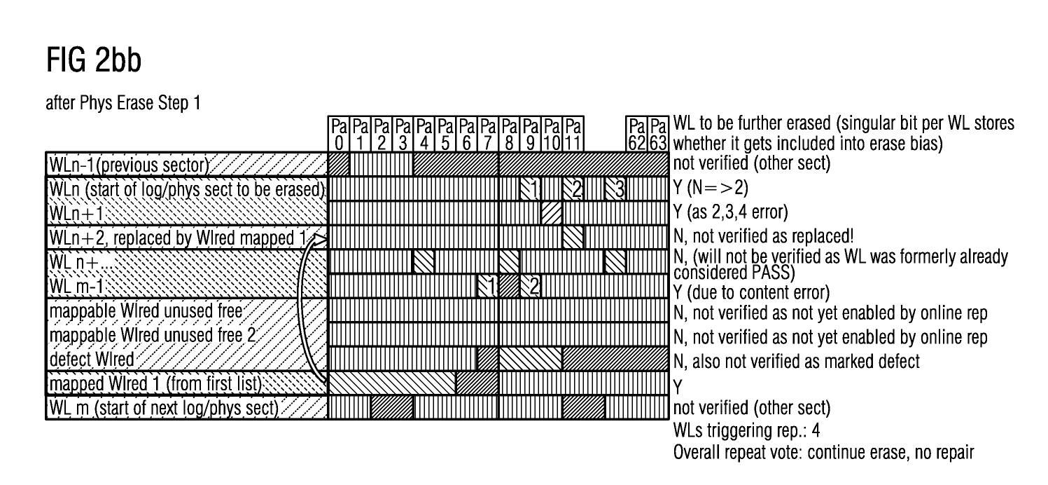

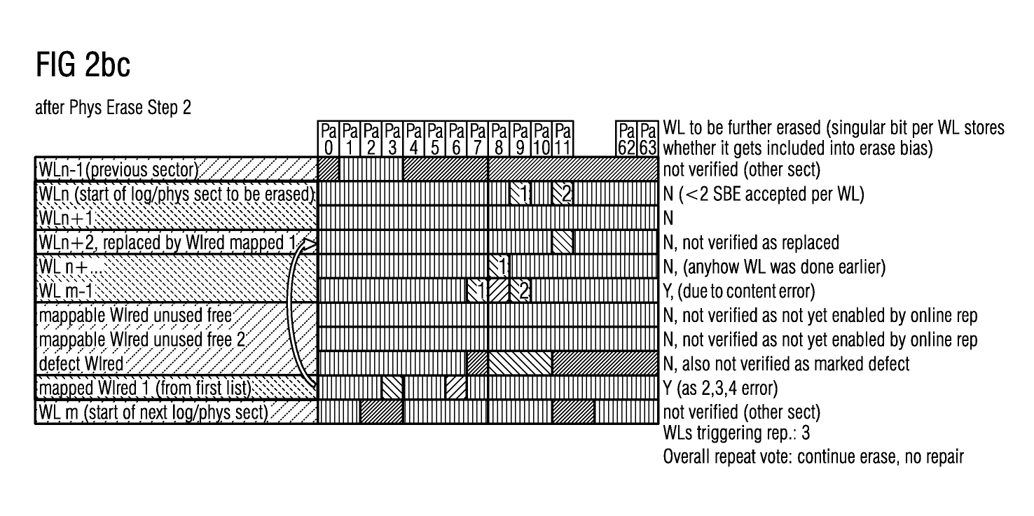

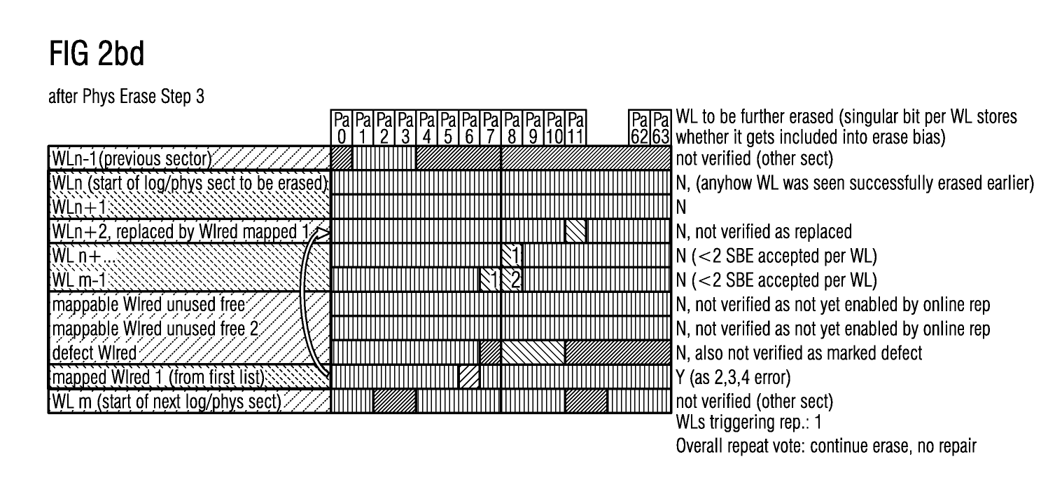

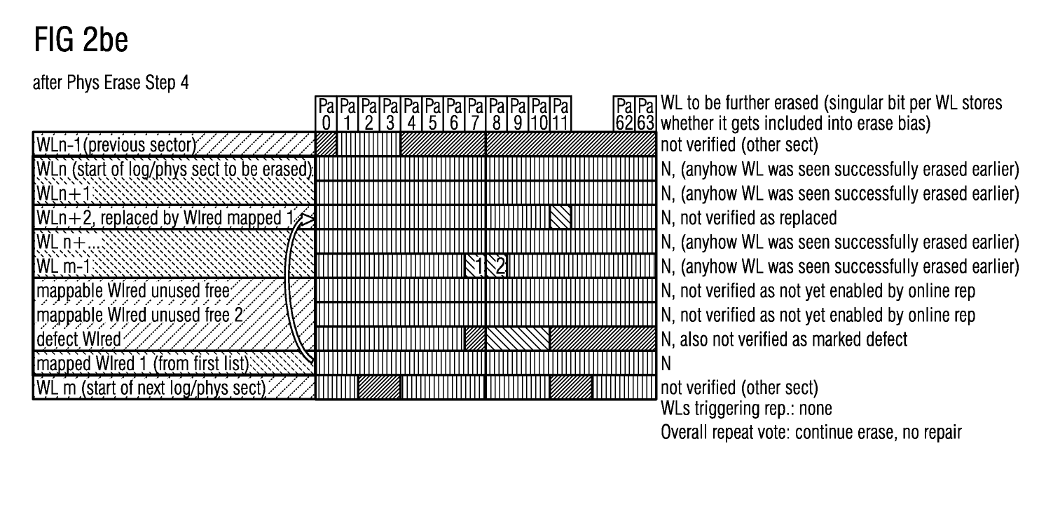

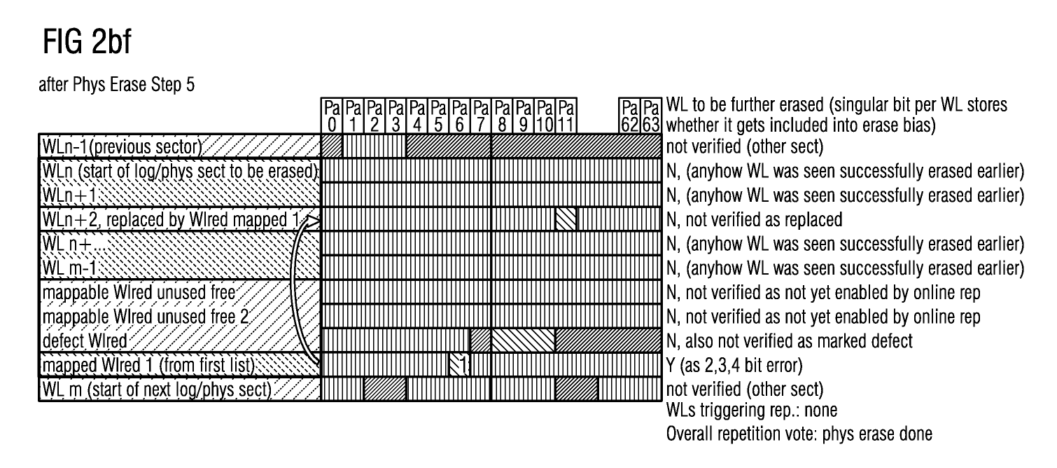

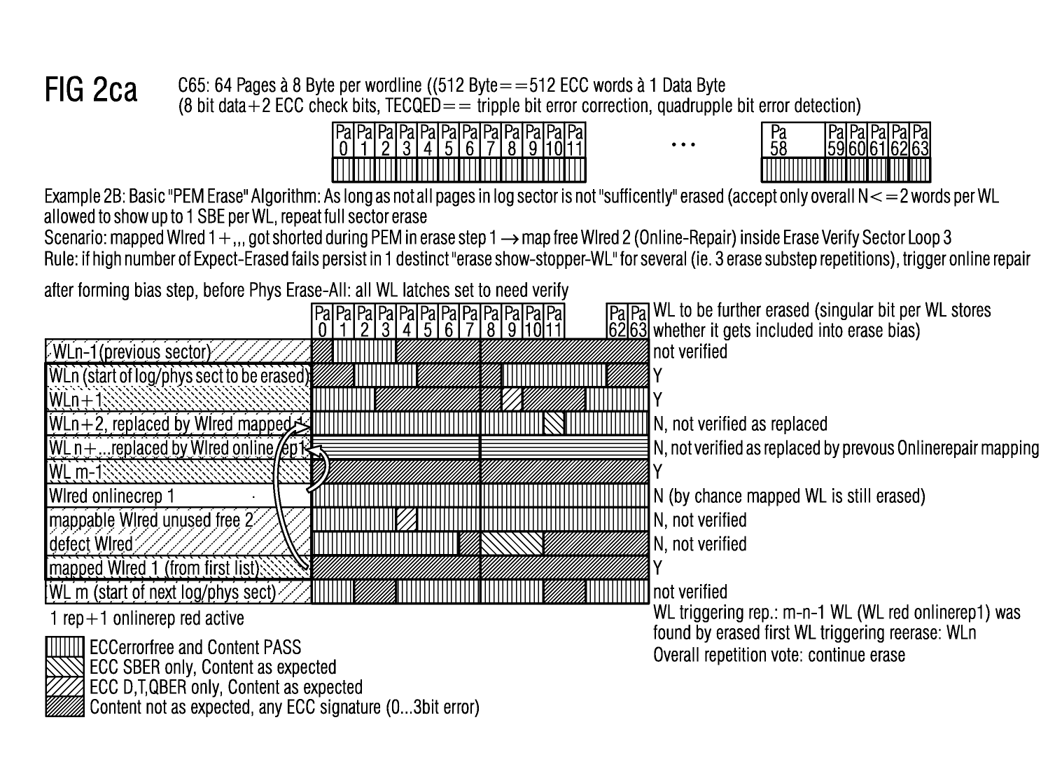

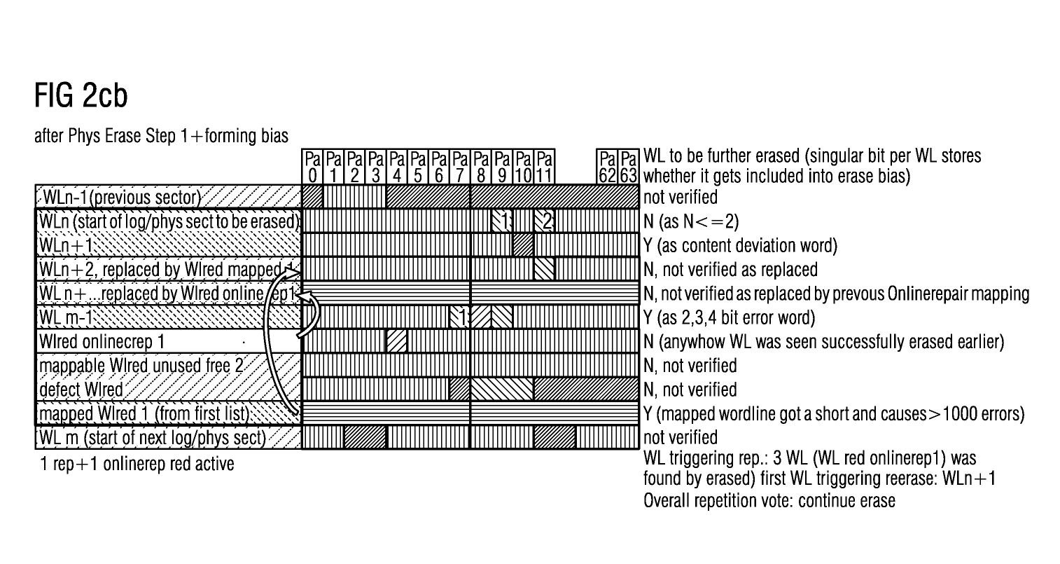

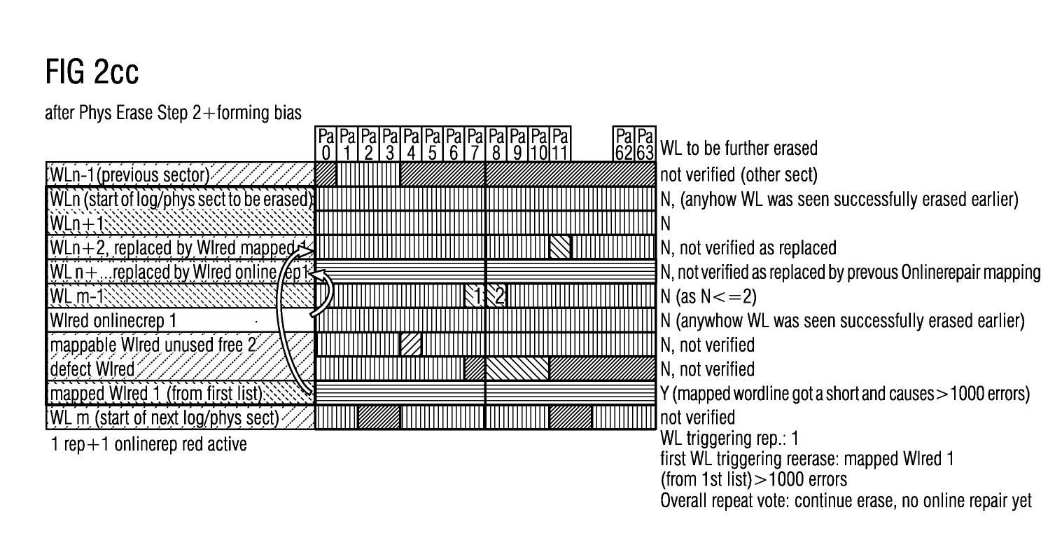

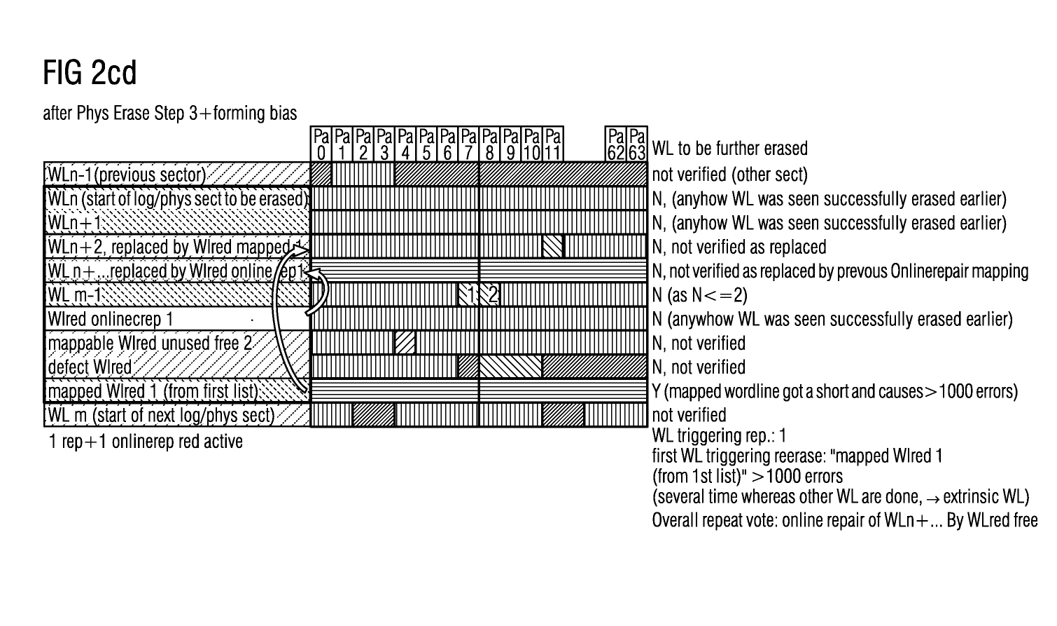

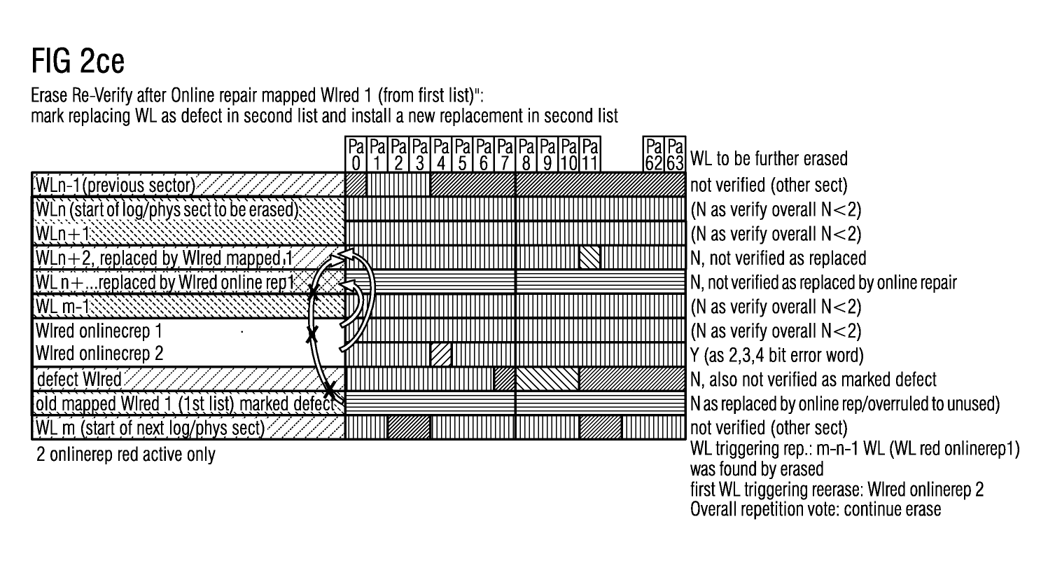

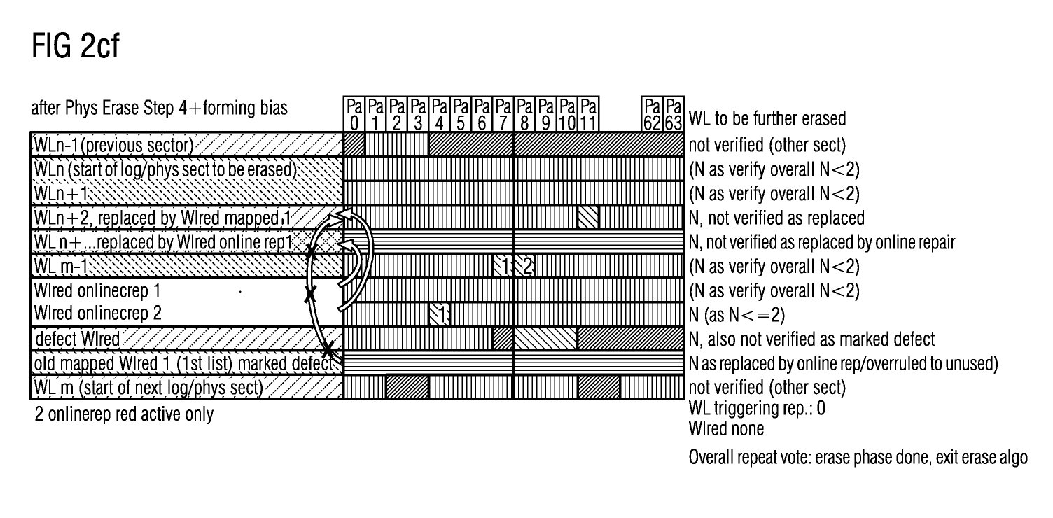

Variants according to the first embodiment may comprise the following algorithms sub-elements of flash repair operations during an erase algorithm. Namely, embodiments may provide a wordline short detection method during erase verify by using an erase verify mode with elevated on-resistance via high voltage wordline drivers. In embodiments, the detection algorithm may be nested into a variety of erase—respectively tearing safe—update algorithms such as a progressive erase mode (PEM) (cf. FIG. 2a) to detect slow or non-erasing wordlines reliably. As described before, additional redundancy elements may be enabled, for example with the help of a second repair list as in the above-mentioned patent related to the “SMART” technology.

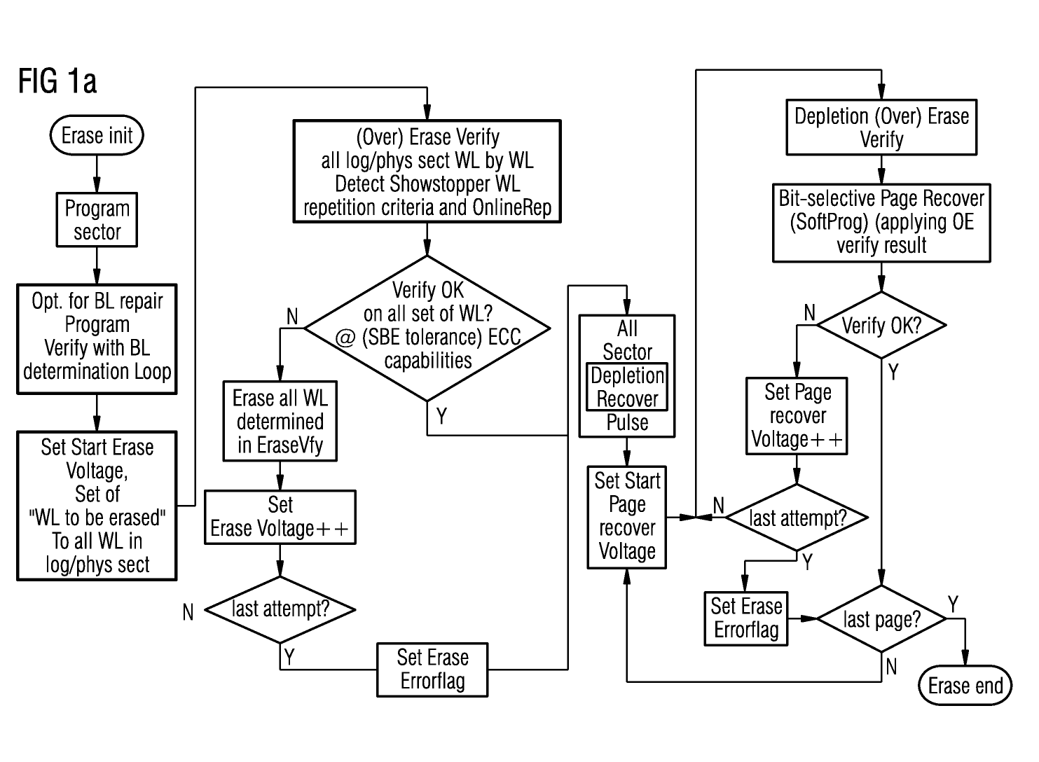

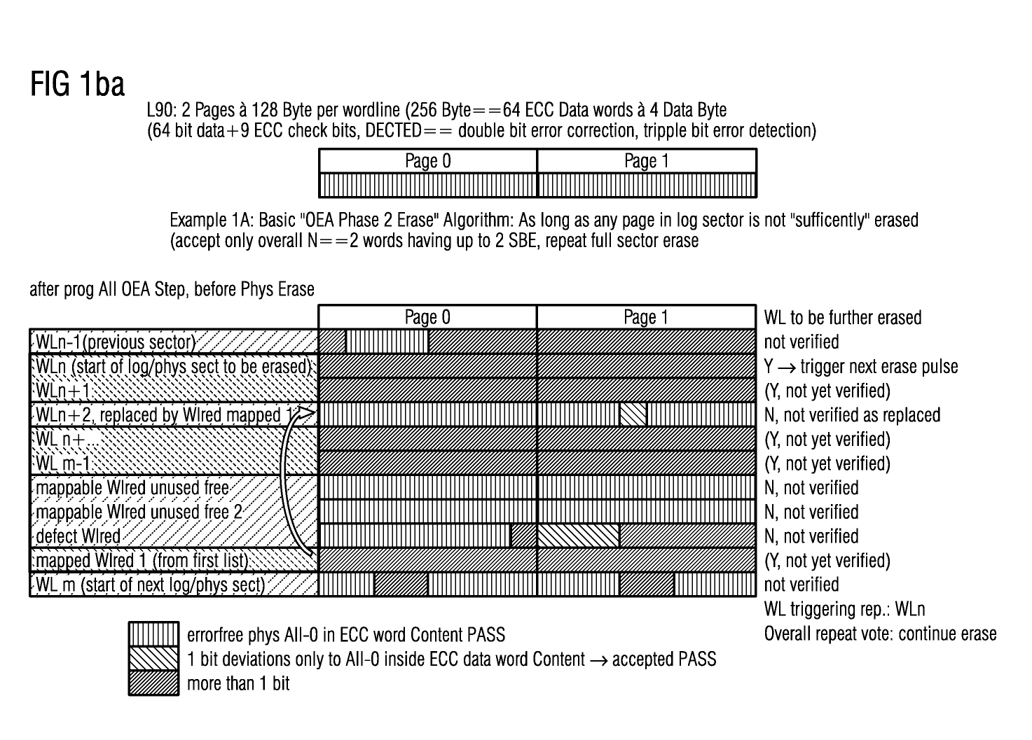

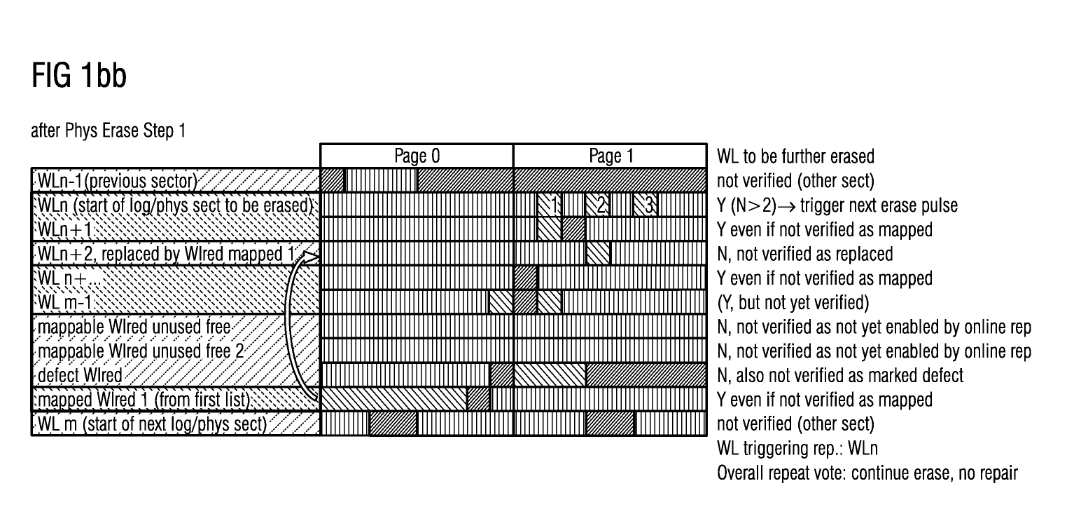

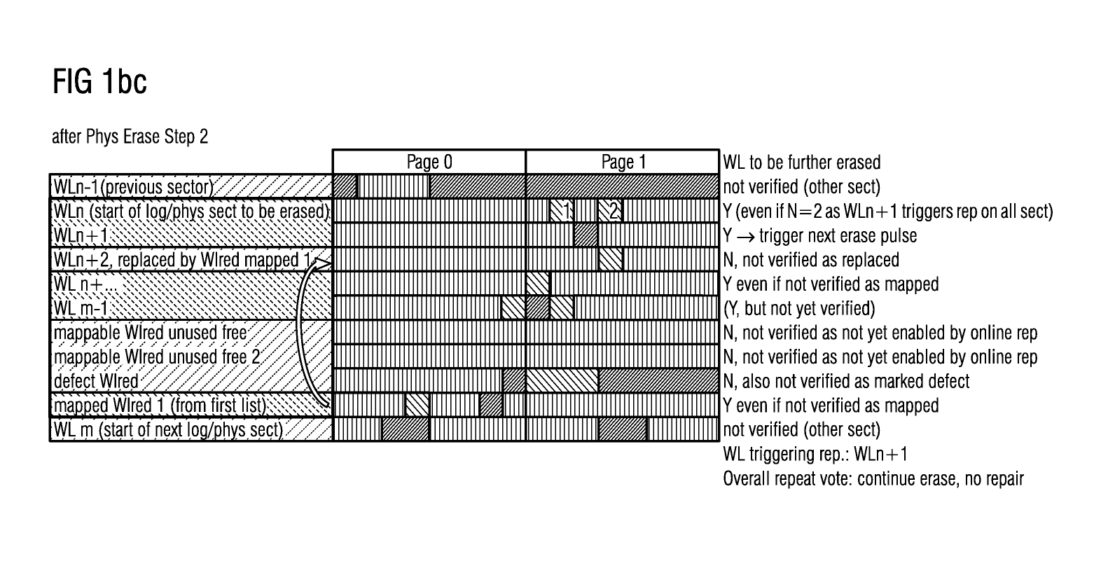

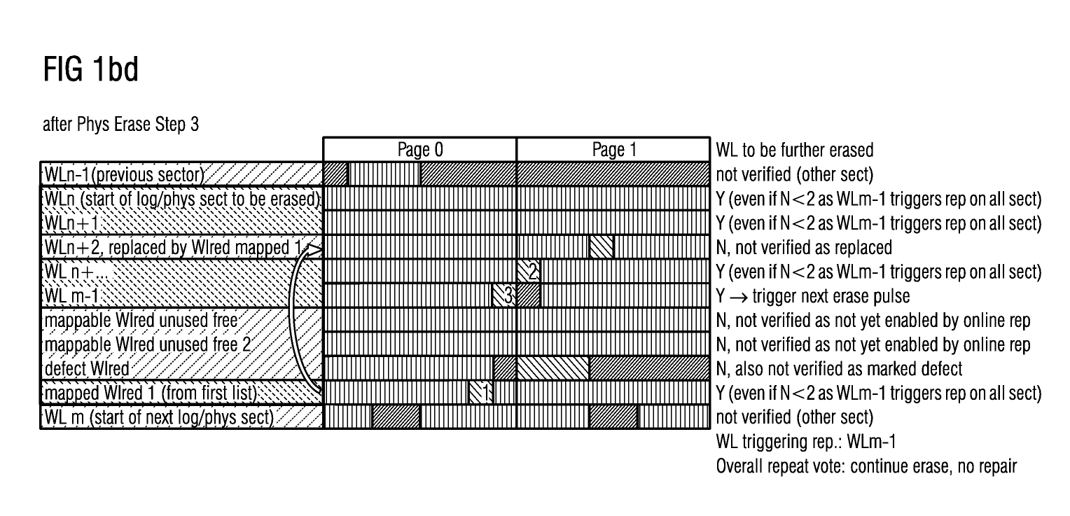

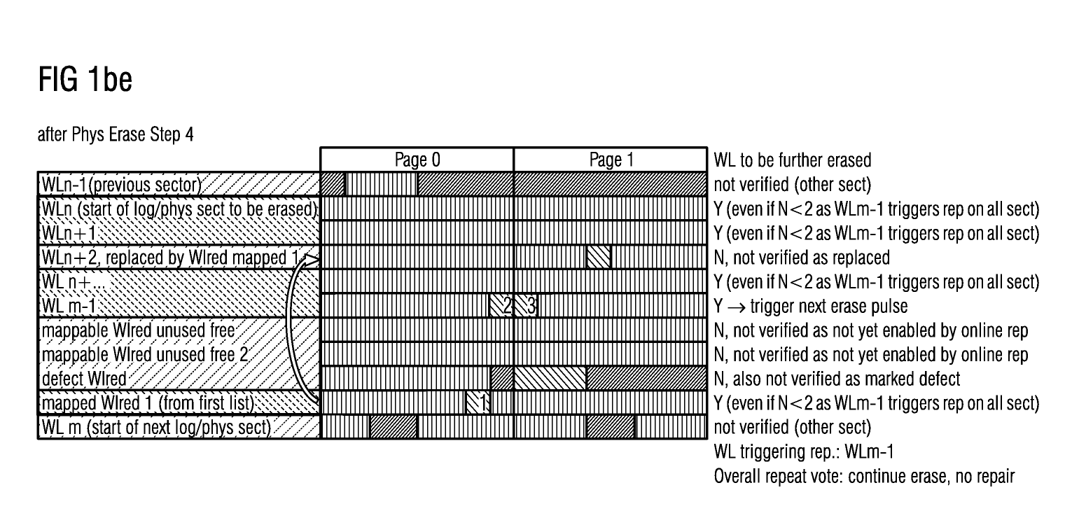

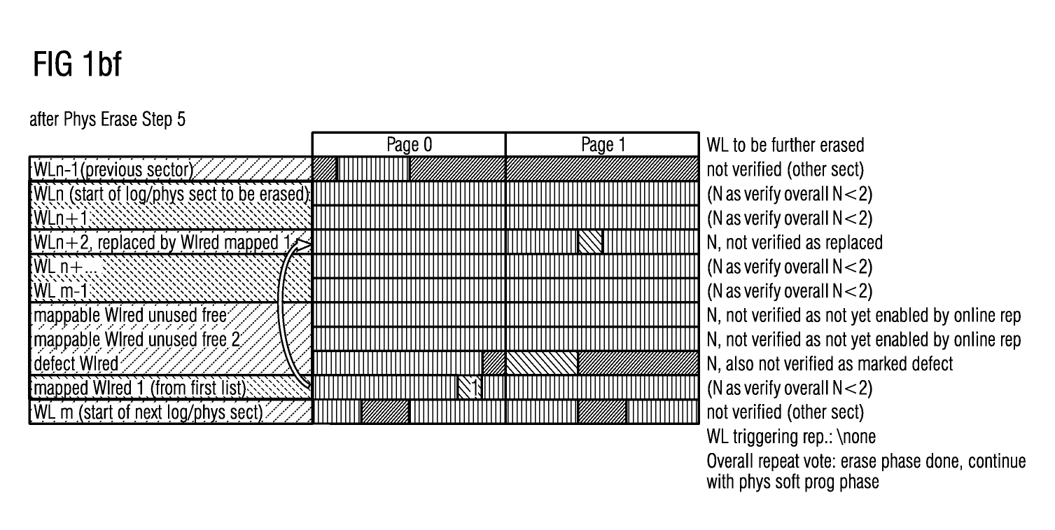

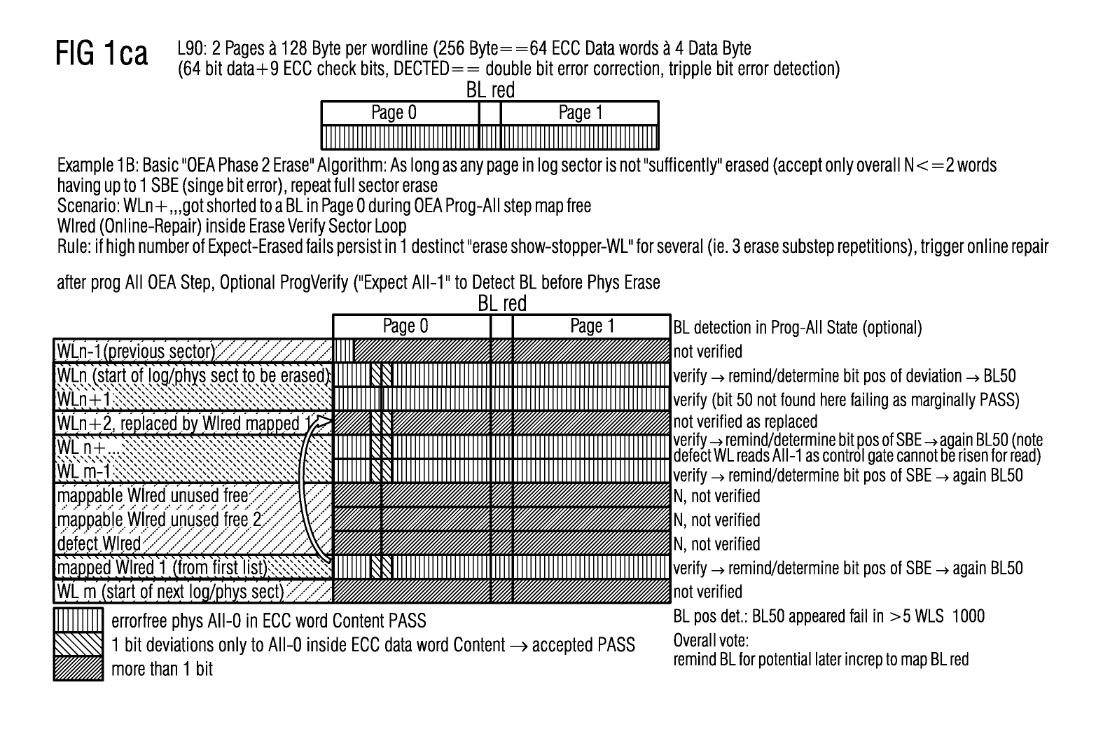

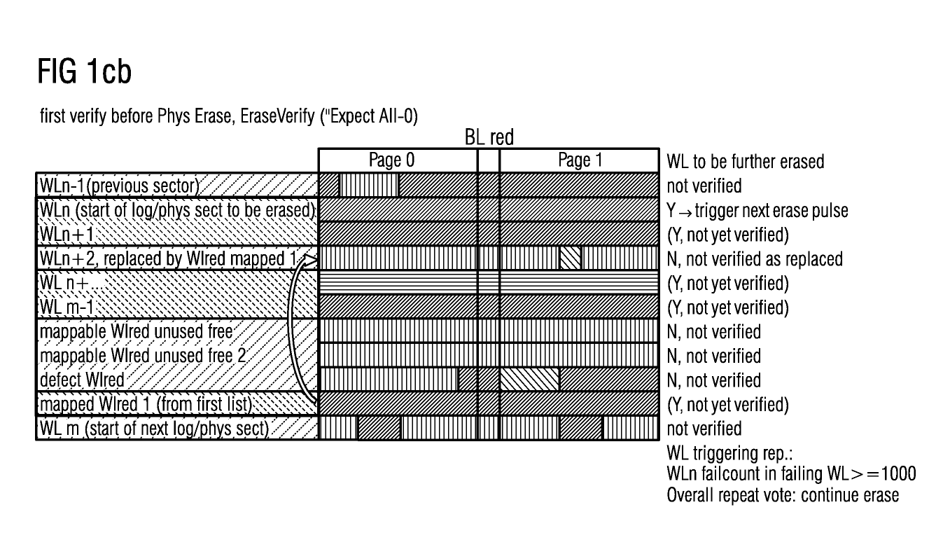

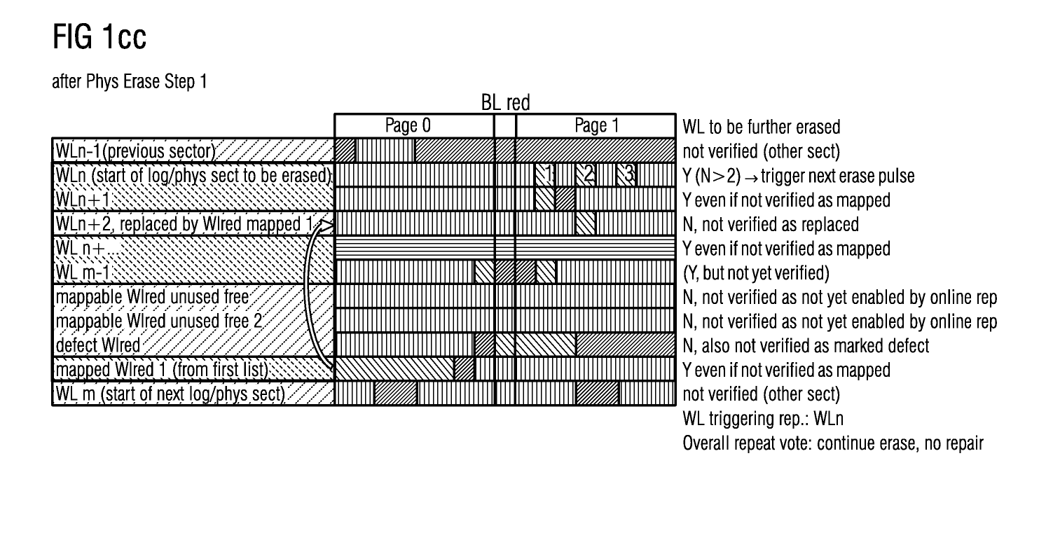

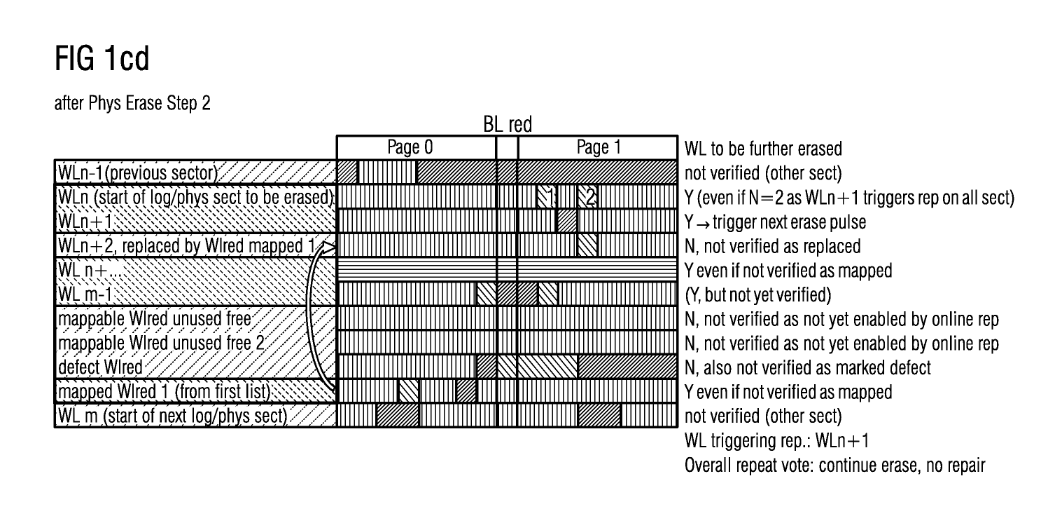

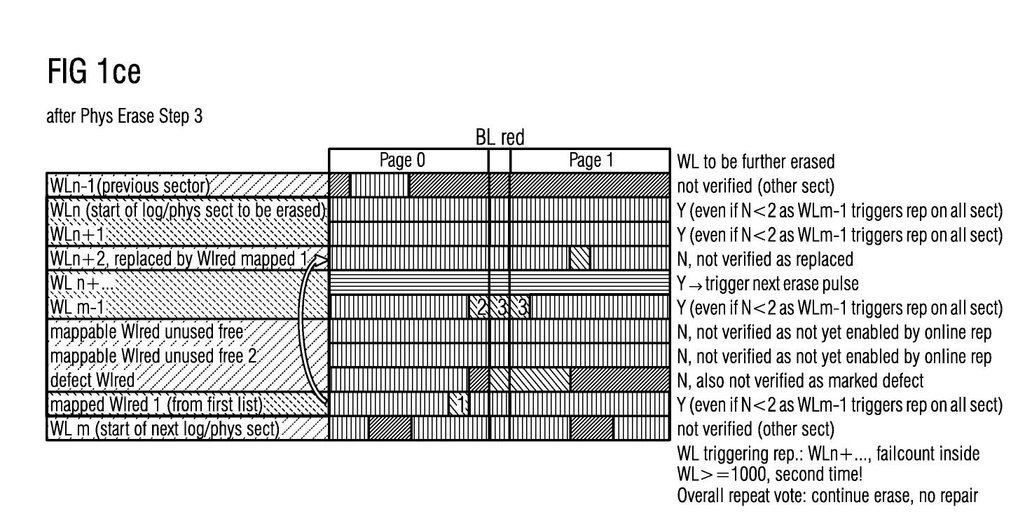

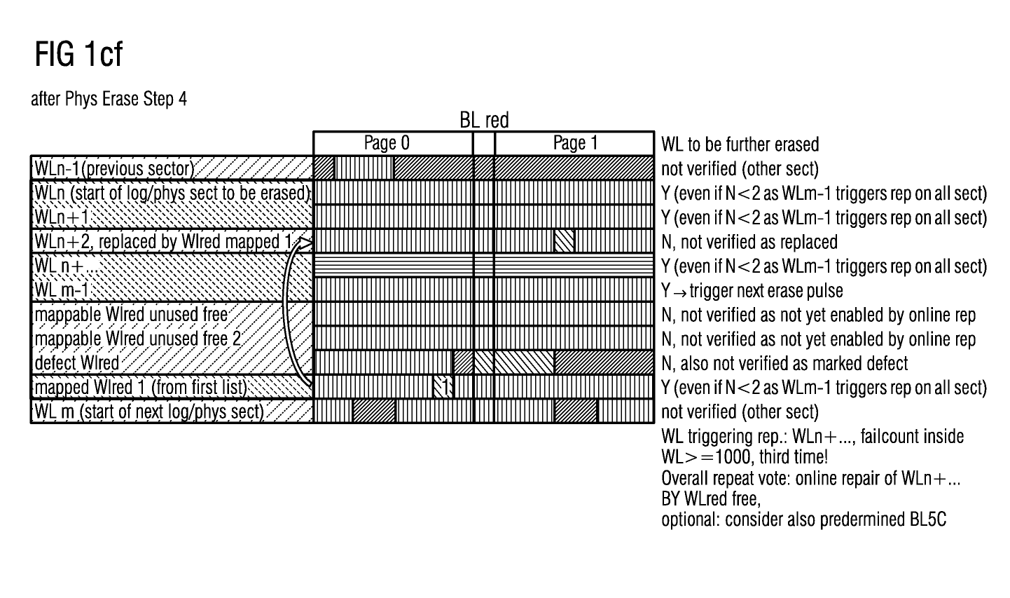

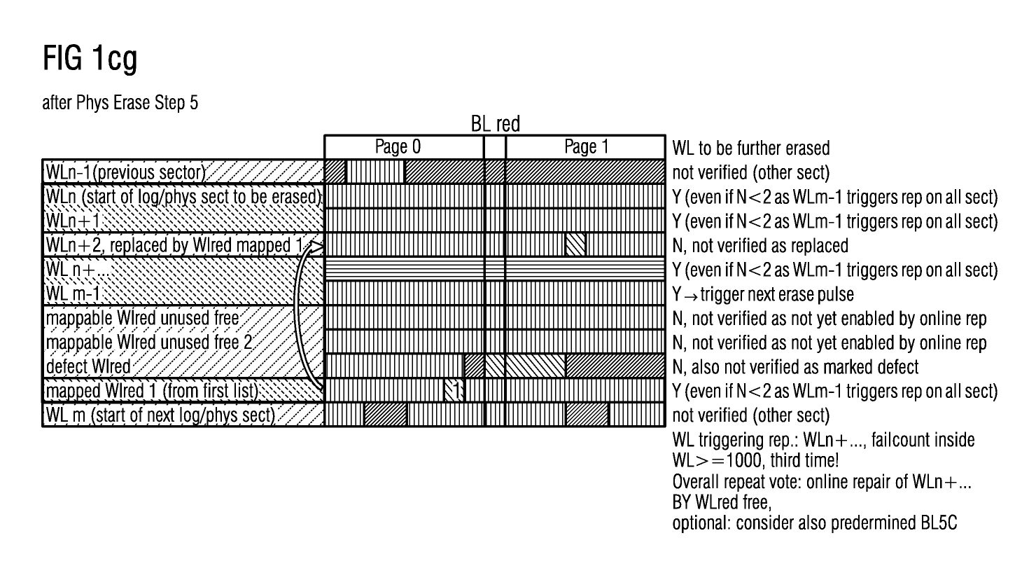

Variants of the first embodiment may comprise storing—by programming only—endangered wordline content to a second redundancy bank buffer in an auxiliary memory ideally in same data flash memory blocks as the endangered wordline, cf. FIGS. 1ca-1ch and. Further embodiments, may even consider cases in which a repaired wordline that is failing is stored to the second redundancy bank, cf. FIGS. 2ca-1cf.

Variants of the second embodiment may use static repair pages of a second spare type as second list of redundancy elements (cf. FIGS. 5 to 21). Embodiments may analyze mapping wordline data fields and determining a usage status of static repair pages by a service algorithm at boot time into physical MapRAM. The service algorithm is required to re-determine MapRAM content matching the page content after tearing or in case of frozen wordline contents and is typical for implicit online repair.

In embodiments, a volatile storage of replacement information for redundant cell-blocks may involve the followings aspects. Firstly, in a fast volatile memory considerations may be involved which content is loaded from one or more tables in a nonvolatile memory.

Secondly, the content may contain replacement information for every redundant wordline, e.g. address information of replaced failing wordline, information about whether the redundant wordline is used and information about whether the redundant wordline is itself failing.

Thirdly, during usage one of the redundant wordlines may fail and then may be replaced by another free redundant wordline. As a result, the coding of redundancy enabling in the second list of redundancy elements may comprise offering a possibility to overrule an redundancy activation mentioned in the first list of redundancy elements. This overruling may redirect replacement to an element specified in the second list of redundancy elements.

Fourthly, the replacement may depend on current data or conditions in the nonvolatile memory. In particular, during erase operation, all target values in the failing cell block may be logical “0”, which is easier than during program operation where there may be different target values in the failing wordline.

In embodiments, a nonvolatile storage of replacement information for redundant wordlines may involve the following aspects. Firstly, it may be generally possible to store the replacement information in the same memory area where the replacement shall occur. For example, the data replacement may be proposed to occur in a user configuration block (UCB) of the data flash to be repaired. Typically, this may be easier than to store the replacement information in another location of the nonvolatile memory.

Secondly, after detection of a fail page or wordline and selection of a usable redundant page or wordline, this change in the replacement information may be stored in the nonvolatile memory. Therefore, additional measures to secure this storage may be needed such as redundant storage and a sufficient or adequate storage format which is prepared to for errors during this storage. For example, CRC markers may be used to detect fails in read back or at boot time evaluation like proposed for a tearing safe programming operation.

Independent from the exact physical fail mode, embodiments of the proposed data flash online repair approach may be able to handle or recover from any extrinsic cycling-induced wordline fails at erase time.

Moreover, embodiments of the proposed data flash online repair approach may be able to handle some extrinsic or partially intrinsic data retention type faults at boot time or erase time. This holds especially for a MapRAM based embodiment if the boot process happens in time to recover data.

The MapRAM may be used to emulate the behavior of an EEPROM based on the flash like behavior of the 1-Transistor (1-T) uniform channel program (UCP) cell field. Every data word in the MapRAM may be protected by an ECC. The MapRAM for each logical page address within every sector of the NVM may contain the associated mapped physical page address and a valid marker, for instance, a CRC field covering the data stored in the page including the ECC.

In variants according to the second embodiment, the MapRAM may additionally contain the physical memory page address of at least one, ideally a plurality of empty spare pages for every sector. If there is a true wordline redundancy with remapping, ideally the spare pages may be kept unused or defect redundancy and are removed from sector type program or erase operations.

The MapRAM may be automatically initialized by the service algorithm after reset with the information from the mapblocks of all pages. In use of a corresponding memory device, dynamic pages are detectable by a valid CRC. In contrast to that, faulty pages may be recognized by their invalid CRC (cf. FIG. 18-21).

The MapRAM mechanism may be switched off for a configurable sector range, resulting in a fixed linear mapping as in conventional flash memory.

FIGS. 1a and 2a show a flow chart of an over erase algorithm and an progressive erase algorithm respectively with online repair extensions according to a variant of the first embodiment.

FIGS. 1ba to 1ch and 2ba to 2cf illustrate the over erase algorithm and an progressive erase algorithm in different memory devices in detailed steps in cases with and without online repair steps.

FIG. 1a shows a flow chart of an over erase algorithm 100 (OEA) or method with online repair extensions according to a variant of a first embodiment.

The algorithm 100 begins with an over erase initialization at block 101. A sector is programmed at block 102. At block 103, an option for BL repair Program Verify with BL determination loop is performed. A set of wordlines (WL) to be erased are selected or identified at block 104. A first (over) erase verify operation is performed at block 105 on the set of WL. A verification is performed on the set of WL at block 106. The verification can, for example, verify compliance with ECC capabilities.

If the verification fails at block 106, failed WL determined or identified in block 106 are erased at block 107. An erase voltage is set at block 108. A check on whether it is a last attempt is performed at block 109, if not, the algorithm 100 can return to block 106 or 107. If yes, an erase error flag is set at block 110 and the algorithm 100 continues to block 111. The erase error flag indicates that an erase error has occurred.

If the verification is OK or successful at block 106, the algorithm 100 also continues to block 111, where a depletion recover is performed. A page recover is performed at block 112. Then, a depletion (over) erase verify is performed at block 113. At block 114, a bit selective page recover is applied. Another verification is performed at block 115.

If the verification at block 115 is not OK, the algorithm 100 continues to block 116 where a page recover voltage is set. A check for a last attempt is performed at block 117. If the check results in a NO, the algorithm 100 returns to block 113. Otherwise, the erase errorflag is set at block 118 and the algorithm 100 continues to a last page check at block 119. Additionally, the algorithm 100 continues from block 115 to block 119 on the verification at block 115 being OK.

If the last page check at block 119 determines that this is the last page, the algorithm 100 continues to block 120, which ends or terminates the over erase. Otherwise, the algorithm 100 returns to block 112.

FIG. 1ba shows a schematical diagram of a memory device with 2 pages of 128 bytes per wordline in an over erase algorithm, such as the algorithm 100, after a “program all” sub step, such as block 102, and before a physical erase step according to the variant of the first embodiment (explicit online-repair).

FIG. 1bb shows a schematical diagram of the memory device in the over erase algorithm 100 according to FIG. 1ba after a first physical erase step according to the variant of the first embodiment.

FIG. 1bc shows a schematical diagram of the memory device in the over erase algorithm 100 according to FIG. 1bb after a second physical erase step according to the variant of the first embodiment.

FIG. 1bd shows a schematical diagram of the memory device in the over erase algorithm 100 according to FIG. 1bc after a third physical erase step according to the variant of the first embodiment.

FIG. 1 be shows a schematical diagram of the memory device in the over erase algorithm 100 according to FIG. 1 bd after a fourth physical erase step according to the variant of the first embodiment.

FIG. 1bf shows a schematical diagram of the memory device in the over erase algorithm 100 according to FIG. 1 be after a fifth physical erase step according to the variant of the first embodiment.

FIG. 1ca shows a schematical diagram of a memory device with 2 pages of 128 bytes per wordline in an over erase algorithm 100 after a “program all” step, an optional “program verify” or “expect all 1” step to detect a defect bitline and before a physical erase step according to the variant of the first embodiment.

FIG. 1cb shows a schematical diagram of the memory device in the over erase algorithm 100 according to FIG. 1ca after a first verify step before a physical erase step and a “erase verify” or “expect all 0” step according to the variant of the first embodiment.

FIG. 1cc shows a schematical diagram of the memory device in the over erase algorithm 100 according to FIG. 1cb after a first physical erase step according to the variant of the first embodiment.

FIG. 1cd shows a schematical diagram of the memory device in the over erase algorithm 100 according to FIG. 1cc after a second physical erase step according to the variant of the first embodiment.

FIG. 1ce shows a schematical diagram of the memory device in the over erase algorithm 100 according to FIG. lcd after a third physical erase step according to the variant of the first embodiment.

FIG. 1cf shows a schematical diagram of the memory device in the over erase algorithm 100 according to FIG. 1ce after a fourth physical erase step according to the variant of the first embodiment.

FIG. 1cg shows a schematical diagram of the memory device in the over erase algorithm 100 according to FIG. 1cf after a fifth physical erase step according to the variant of the first embodiment.

FIG. 1ch shows a schematical diagram of the memory device in the over erase algorithm 100 according to FIG. 1 cg after an erase re-verify step after an online repair step according to the variant of the first embodiment.

FIG. 2a shows a flow chart of a progressive erase algorithm (PEM) 200 or method with online repair extensions according to a further variant of the first embodiment.

The algorithm 200 begins at block 201 where the progressive erase is initiated. At block 202, a start erase voltage is set for WL to be erased to all WL in a logical or physical sector. A bias voltage is formed on the set of still to be erased WL at block 203. An over erase verification is performed on all logical/physical sector WL by WL at block 204.

If the over erase verification is OK at block 205, the algorithm continues to block 210. If the over erase verification is not OK at block 205, the algorithm 200 continues to block 206 where a set of WL identified at block 205 is set to be erased at block 206. At block 207, an erase voltage is set for the set of WL identified at block 205.

A check is performed at block 208 on whether this is a last attempt for the set of WL. If no, the algorithm 200 returns to block 203. Otherwise, the algorithm continues at block 209 where an erase errorflag is set. Subsequently, the progressive erase is ended at block 210.

FIG. 2ba shows a schematical diagram of a memory device with 64 pages of 8 bytes per wordline in the progressive erase algorithm 200 after a forming bias step 203 and before a physical “erase all” step according to the further variant of the first embodiment.

FIG. 2bb shows a schematical diagram of the memory device in the progressive erase algorithm 200 according to FIG. 2ba after a first physical erase step 204 according to the further variant of the first embodiment.

FIG. 2bc shows a schematical diagram of the memory device in the progressive erase algorithm 200 according to FIG. 2bb after a second physical erase step according to the further variant of the first embodiment.

FIG. 2bd shows a schematical diagram of the memory device in the progressive erase algorithm 200 according to FIG. 2bc after a third physical erase step according to the further variant of the first embodiment.

FIG. 2be shows a schematical diagram of the memory device in the progressive erase algorithm 200 according to FIG. 2bd after a fourth physical erase step according to the further variant of the first embodiment.

FIG. 2bf shows a schematical diagram of the memory device in the progressive erase algorithm 200 according to FIG. 2be after a fifth physical erase step according to the further variant of the first embodiment.

FIG. 2ca shows a schematical diagram of a memory device with 64 pages of 8 bytes per wordline in the progressive erase algorithm 200 after a forming bias step before a physical “erase all” step according to the further variant of the first embodiment.

FIG. 2cb shows a schematical diagram of the memory device in the progressive erase algorithm 200 according to FIG. 2ca after a first physical erase step and forming bias step according to the further variant of the first embodiment.

FIG. 2cc shows a schematical diagram of the memory device in the progressive erase algorithm 200 according to FIG. 2cb after a second physical erase step and forming bias step according to the further variant of the first embodiment.

FIG. 2cd shows a schematical diagram of the memory device in the progressive erase algorithm 200 according to FIG. 2cc after a third physical erase step and forming bias step according to the further variant of the first embodiment.

FIG. 2ce shows a schematical diagram of the memory device in the progressive erase algorithm 200 according to FIG. 2cd after an erase re-verify step after an online repair step according to the further variant of the first embodiment.

FIG. 2cf shows a schematical diagram of the memory device in the progressive erase algorithm 200 according to FIG. 2ce after a fourth physical erase step and forming bias step according to the further variant of the first embodiment.

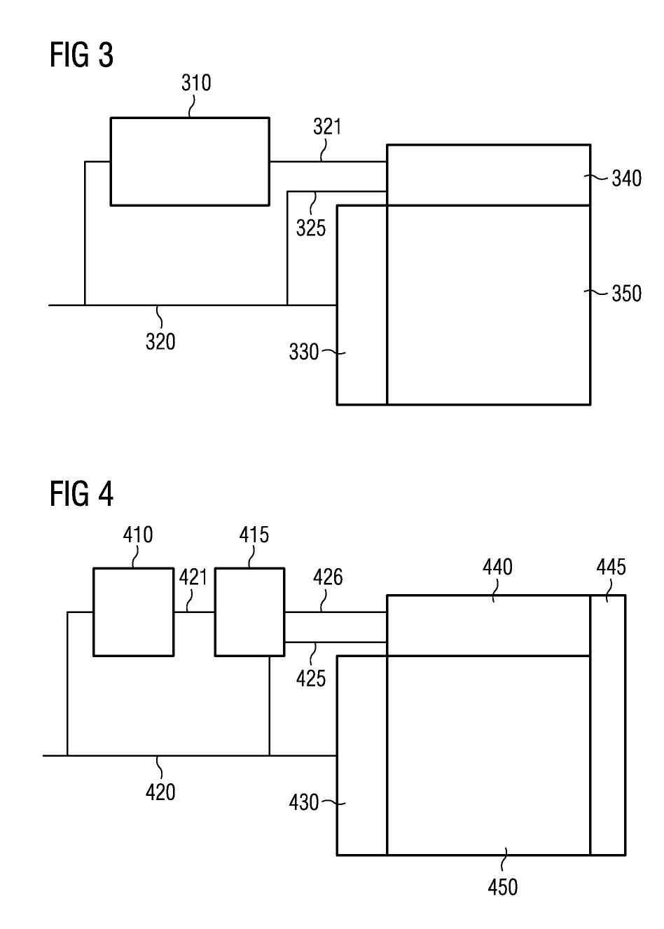

FIG. 3 shows a schematical overview 300 of addressing memory elements of memory field via a MapRAM table in the address path according to a variant of the second embodiment. As shown in FIG. 3, the address bus 320 may be coupled to the MapRAM table 310 as mapping table and to the bitline driver 330. The MapRAM table 310 may provide wordline addresses to a wordline driver 340 via a wordline address path 321. Moreover, the address bus 320 may provide a sector address via a sector address path 325 to the wordline driver 340. Both, the wordline driver 340 and the bitline driver 330 may cooperate to use the addresses provided via the address bus 320, the wordline address path 321 and the sector address path 325 to address a particular memory cell of the non-volatile memory field 350.

FIG. 4 shows a schematical overview 400 of addressing memory elements of memory field via a MapRAM table and a redundancy bank in the address path according to a variant of the first embodiment. As shown in FIG. 4, the address bus 420 may be coupled to the MapRAM table 410 as mapping table and to the bitline driver 430. The MapRAM table 410 may provide wordline addresses via a wordline address path 421 to a redundancy bank 415 for mapping fixed redundant wordlines of the redundant wordlines 445 of a memory field 450 in case wordline defects have been detected. As a result, the redundancy bank 415 provides possibly modified wordline addresses to a wordline driver 440 via a path 426 for modified wordline addresses. Moreover, the address bus 420 may provide a sector address via a sector address path 425 to the wordline driver 440. Both, the wordline driver 440 and the bitline driver 430 may cooperate to use the addresses provided via the address bus 420, the path 426 for modified wordline addresses and the sector address path 425 to address a particular memory cell of the non-volatile memory field 450.

Insofar, the embodiment in FIG. 4 represents an embodiment that uses a combination of a fixed mapping of defect wordlines to redundant wordlines via the redundancy bank 415 mapper and a dynamic mapping of logical wordlines to physical wordlines by the MapRAM table 410. Typically, the wordline mapping of the redundancy bank 415 is only updated whenever the memory device is reset and defect wordlines have been detected during the prior operation. In contrast to that, the mapping of the MapRAM table 410 is dynamically updated during normal operation of the memory device. In this regard, the embodiments according to FIG. 4 may reach a comprise between the advantages of a fixed redundancy mapping by redundancy bank 415 and a dynamic redundancy mapping by MapRAM table 410. As such, the fixed mapping may be more reliable since the need for remappings is typically determined during more reliably defined operation states of the memory device, whereas the dynamic mappings of the MapRAM table 410 may also occur in less well defined operating conditions possibly leading to incorrect redundancy mappings. However, the dynamic mapping algorithm may enable a better detection of only gradually affected wordlines and correspondingly also better handle only gradually pronounced memory problems.

FIG. 5 shows a mapping table 502 and a corresponding table of nonvolatile memory pages 504 to illustrate a mapping algorithm according to a variant of the second embodiment. An assembly buffer 506 is also included in FIG. 5. The mapping table 502 on the left may start with a linear mapping between logical and physical memory pages. Namely, the logical memory page 0 may be mapped to the physical memory page 0, the logical memory page 1 may be mapped to the physical memory page 1, and so on. Moreover, a first logical spare page may be mapped to the physical memory page 8, whereas a second logical spare page may be mapped to the physical memory page 7. The table of physical nonvolatile memory pages 504 on the right of FIG. 5 shows that, besides an identifier or address of a physical memory page and the page data, the corresponding map info—i.e. the logical memory page the corresponding physical memory page is mapped to—may be stored as well as a marker—e.g. CRC code (here “v” for valid)—designating that the corresponding page data is valid. The table of physical nonvolatile memory pages 504 is also referred to as a MapRAM table.

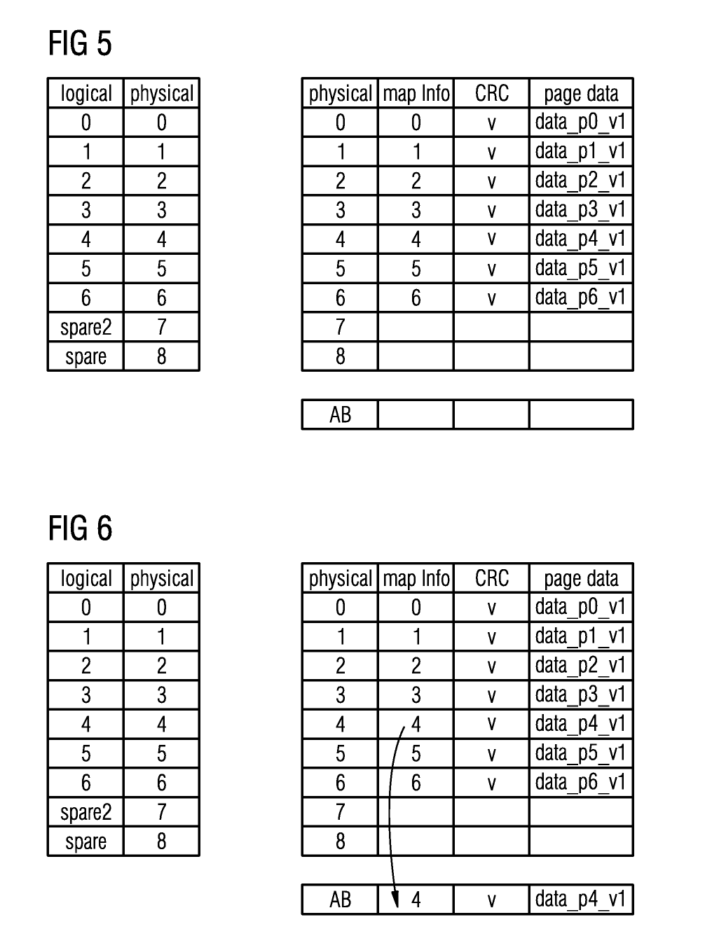

In the following, FIGS. 6 to 10 show which steps may be taken to change the content of logical memory page 4 of the table of physical nonvolative memory pages 504. For that purpose, according to FIG. 6 the page data of logical memory page 4, together with the map info and the CRC field may be copied to the assembly buffer (AB) 506.

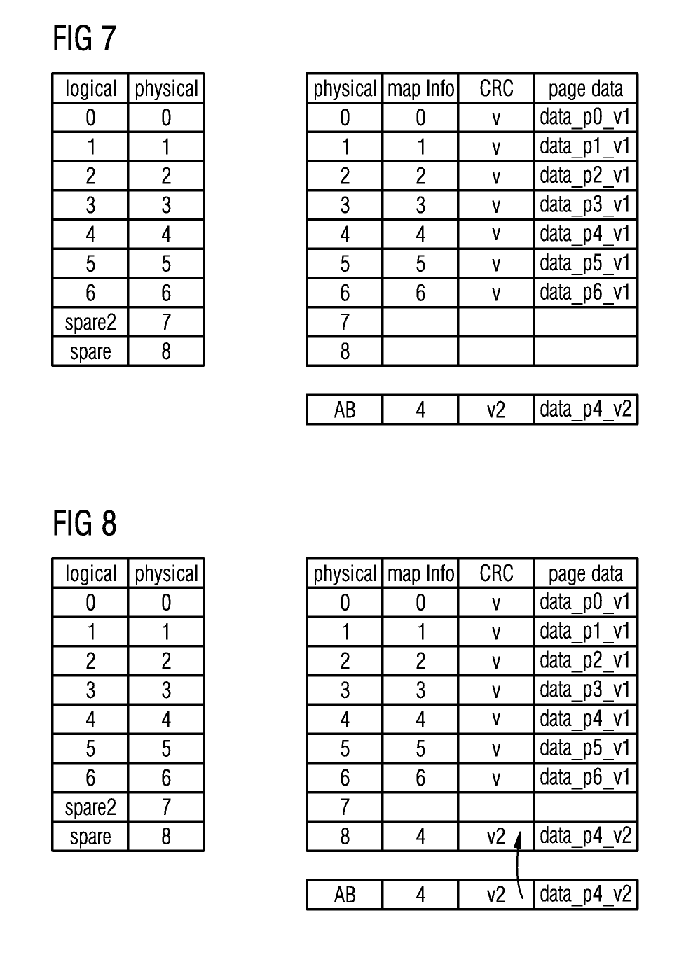

As shown in FIG. 7, the page data and the CRC field of the assembly buffer may then be changed to clarify that the corresponding page data and the CRC field values as stored in the assembly buffer 506 represent second versions of the page data value “data_p4_v1”—here designated as “data_p4_v2”—and the CRC field value “v”—here designated as “v2”.

According to FIG. 8, the values of the page data the CRC field and the map info in the assembly buffer 506 may then be written to the first logical spare page—here designated as “spare”. Since the first logical spare page is mapped to physical memory page 8 in the mapping table 502, the values of the assembly buffer 506 are actually written to physical memory page 8. The content of physical memory page 8 may be double-checked via read back by a high voltage wordline driver path.

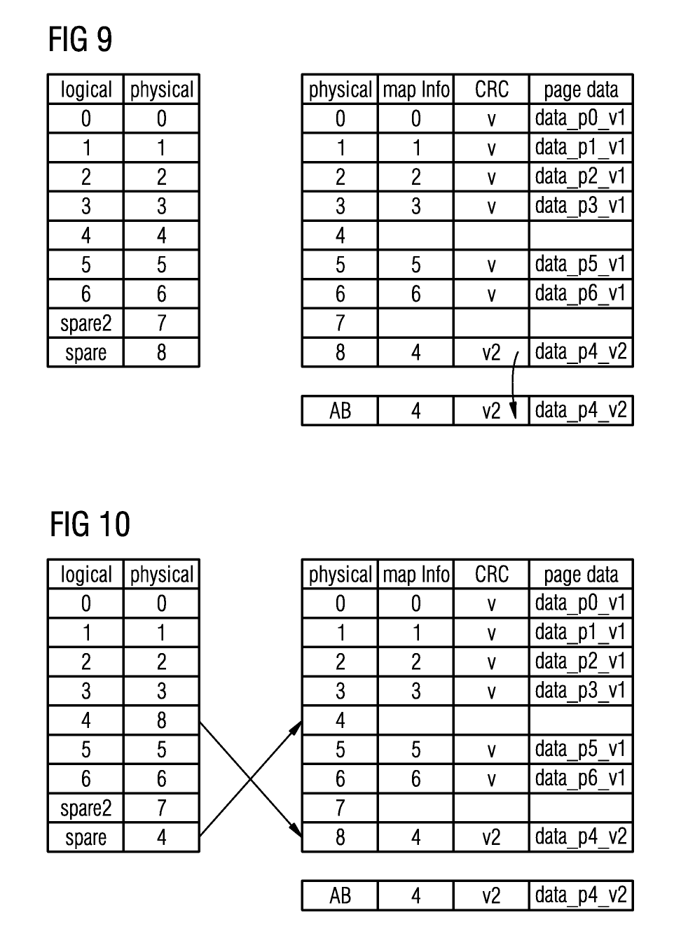

As shown in FIG. 9, the content of the logical memory page 4 may then be erased. Since the logical memory page 4 is mapped to physical memory page 4 in the mapping table 502 according to FIG. 9, the content of logical memory page 4 is actually erased in physical memory page 4 as shown in the table of pages 504. The content of physical memory page 4 may be blank checked via read back by a high voltage wordline driver path.

According to FIG. 10, the MapRAM table 504 may then be updated. Thus, i.e., logical memory page 4 may be mapped to the physical memory page in the mapping table 504 where the content of logical memory page 4 has been written to, namely physical memory page 8. Moreover, the first logical spare page may be mapped to the new free physical memory page in the mapping table 502, namely physical memory page 4.

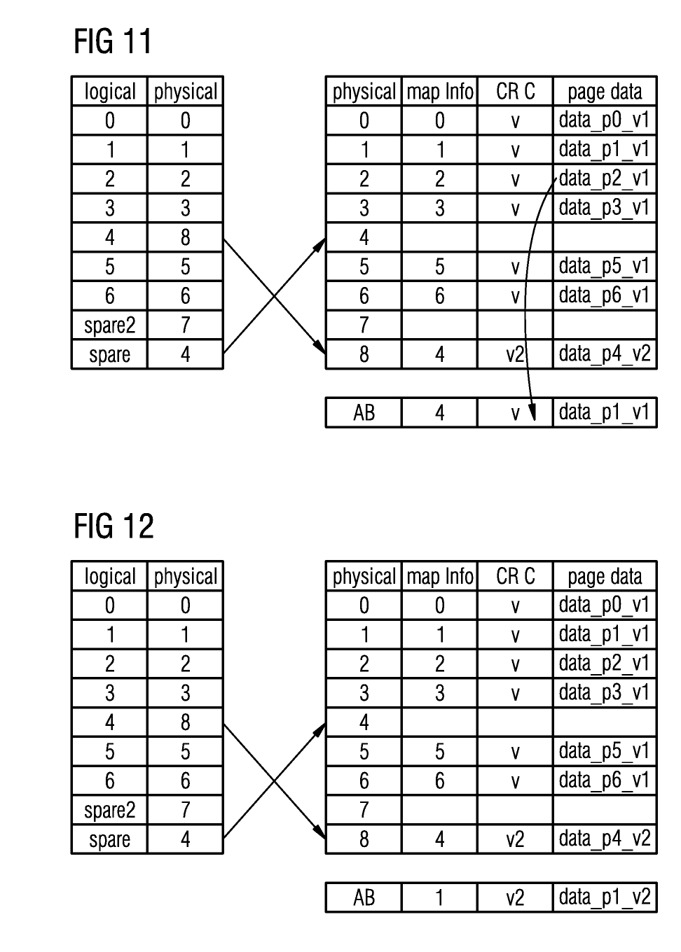

In the following, FIGS. 11 to 15 show which steps may be taken to change the content of logical memory page 1. For that purpose, according to FIG. 11 the page data of logical memory page 1, together with the map info and the CRC field may be copied to the assembly buffer 506.

As shown in FIG. 12, the page data and the CRC field of the assembly buffer 506 may then be changed to clarify that the corresponding page data and the CRC field values as stored in the assembly buffer represent second versions of the page data value “data_p1_v1”—here designated as “data_p1_v1”—and the CRC field value “v”—here designated as “v2”.

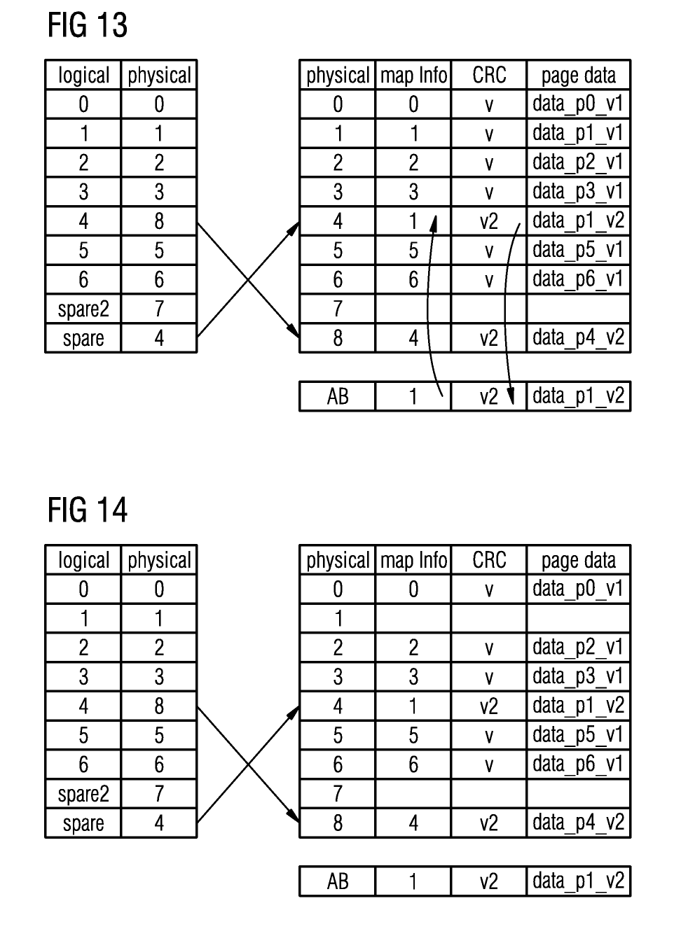

According to FIG. 13, the values of the page data the CRC field and the map info in the assembly buffer may 506 then be written to the first logical spare page—here designated as “spare” of the table of pages or the MapRAM table 504. Since the first logical spare page is mapped to physical memory page 4 in the mapping table 502, the values of the assembly buffer 506 are actually written to physical memory page 4. The content of physical memory page 4 may be double-checked via read back by a high voltage wordline driver path.

As shown in FIG. 14, the content of the logical memory page 1 may then be erased. Since the logical memory page 1 is mapped to physical memory page 1 in the mapping table 502 according to FIG. 14, the content of logical memory page 1 is actually erased in physical memory page 1. The content of physical memory page 1 may be blank-checked via read back by a high voltage wordline driver path.

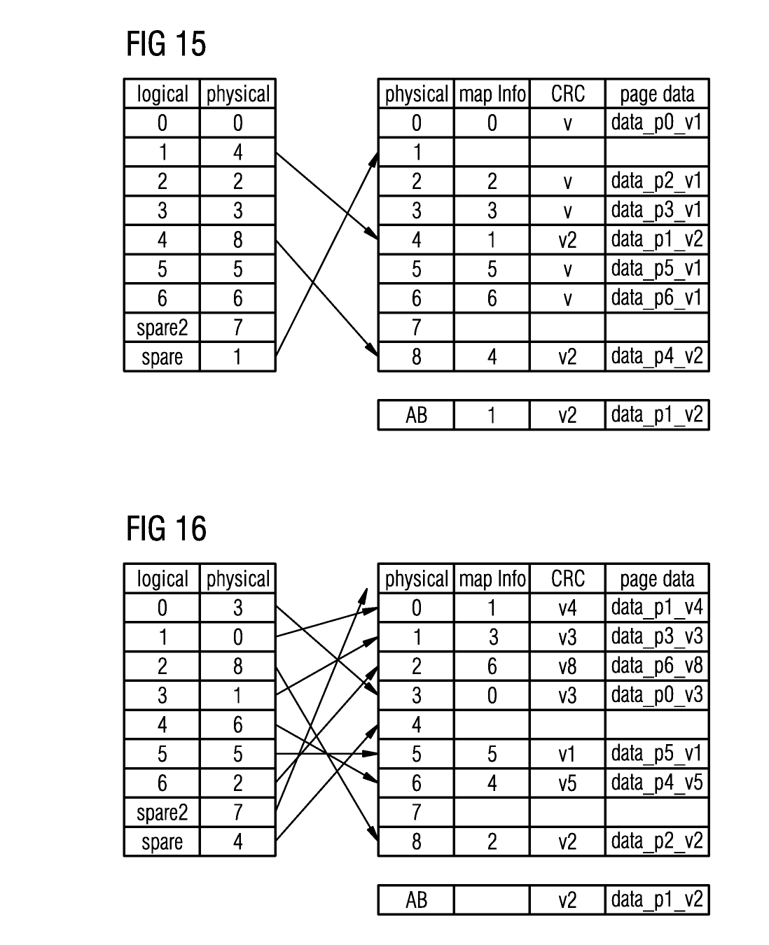

According to FIG. 15, the MapRAM table 504 may then be updated. Thus, i.e., logical memory page 1 may be mapped to the physical memory page in the mapping table where the content of logical memory page 1 has been written to, namely physical memory page 4. Moreover, the first logical spare page may be mapped to the new free physical memory page in the mapping table 502, namely physical memory page 1.

Subsequently, FIG. 16 illustrates the mapping algorithm after 23 programming or re-mapping steps according to the examples in FIGS. 5 to 10 and FIGS. 11 to 15.

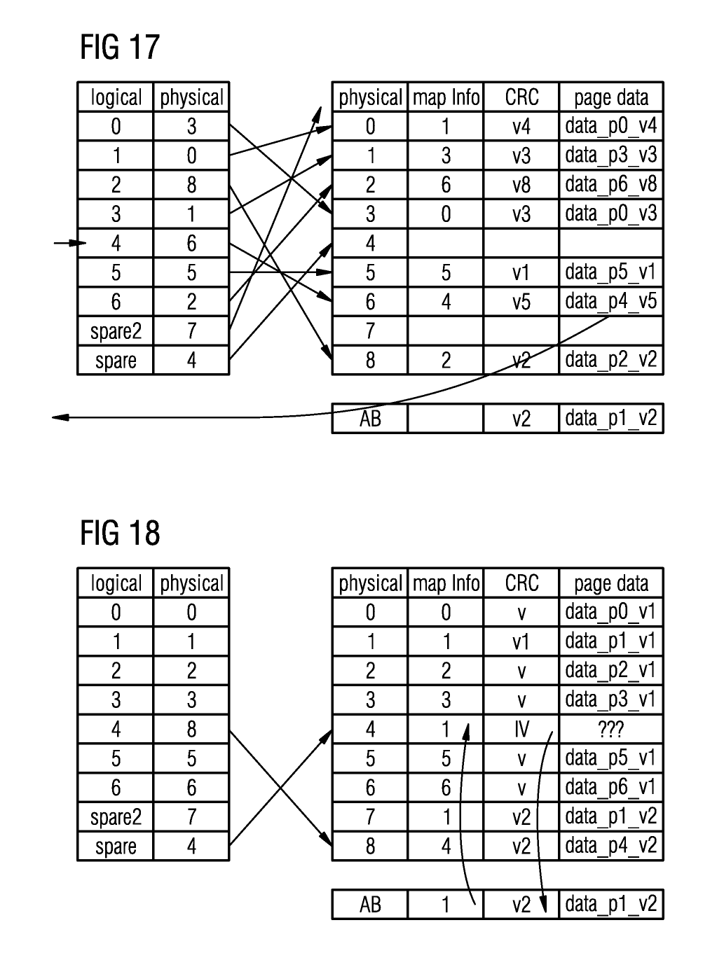

Moreover, FIG. 17 illustrates a read access to logical memory page 4 after the 23 exemplary programming steps. Since the logical memory page 4 is mapped to physical memory page 6 in the mapping table according to FIG. 17, the values “data_p4_v5” and “v5” are read as page data value and the CRC field value respectively from physical memory page 6 as content of logical memory page 4.

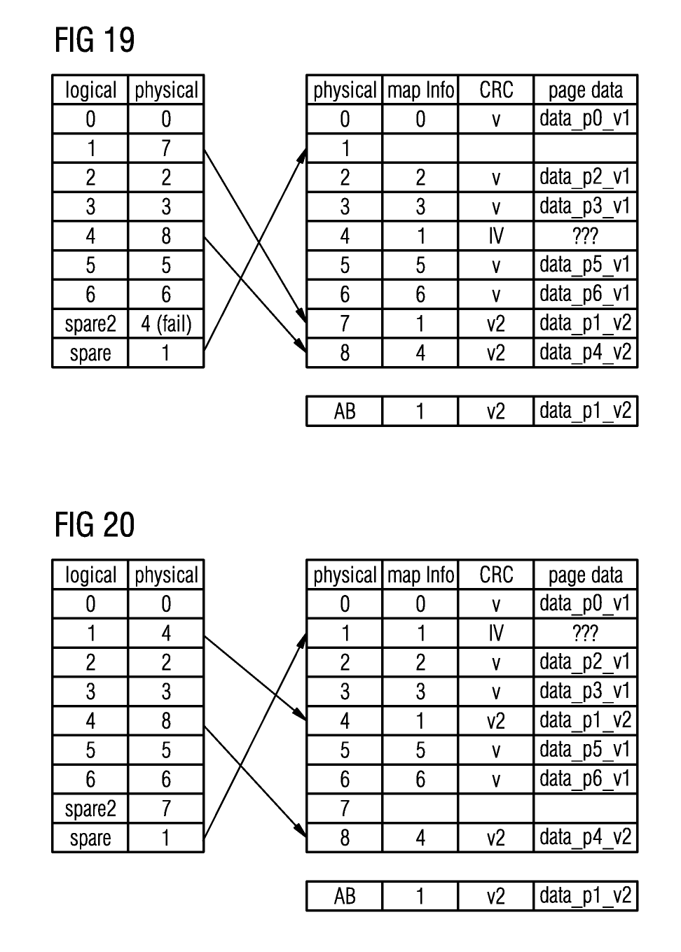

In the following, FIGS. 18 to 19 show a variant to the example in FIG. 13 wherein the writing to the first spare logical memory page—that is mapped to physical memory page 4—is double-checked as unsuccessful via read back by a high voltage wordline driver path. Moreover, the correspondingly invalid content of physical memory page 4 may be marked as such by writing the value “iv” for invalid to the CRC field value of physical memory page 4. To save the content of the assembly buffer 506, the content may also be written to a second spare logical memory page. Since the second logical spare page is mapped to physical memory page 7 in the mapping table 502, the values of the assembly buffer are actually written to physical memory page 7. Also the content of physical memory page 7 may be double-checked via read back by a high voltage wordline driver path.

As shown in FIG. 19, the content of logical memory page 1 was erased. Since logical memory page 1 was mapped to physical memory page 1 in the mapping table 502 according to FIG. 18, the content of logical memory page 1 was actually erased in physical memory page 1. Furthermore, FIG. 19 shows, that the MapRAM table 504 was then updated. i.e., logical memory page 1 was mapped to the physical memory page in the mapping table where the content of logical memory page 1 has been written to, namely physical memory page 7. Moreover, the first logical spare page was mapped to the new free physical memory page in the mapping table 502, namely physical memory page 1. Finally, the second logical spare page was mapped to the invalid physical memory page in the mapping table 502, namely physical memory page 4 and marked as invalid.

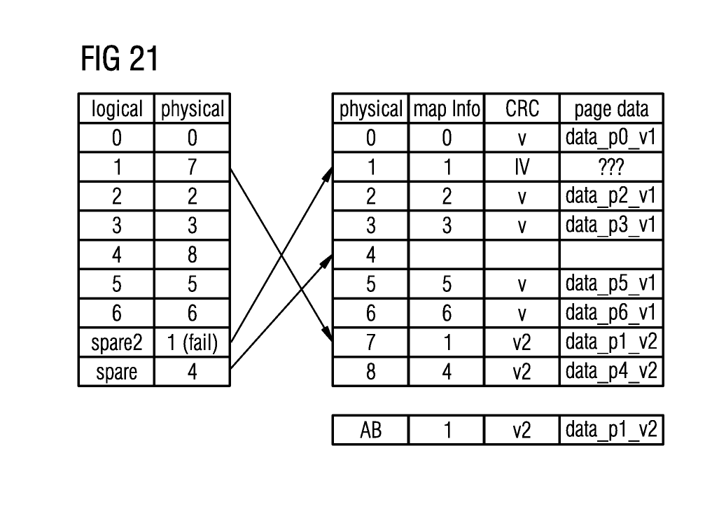

In the following, FIGS. 20 to 21 show a variant to the example in FIG. 14 wherein the erasing of to the first spare logical memory page—that is mapped to physical memory page 1—is double-checked as unsuccessful via read back by a high voltage wordline driver path. In particular FIG. 20 shows that the correspondingly invalid content of physical memory page 1 may be marked as such by writing the value “iv” for invalid to the CRC field value of physical memory page 1.

As shown in FIG. 21, to save the content of the assembly buffer 506, the content may also be written to the second spare logical memory page. Since the second logical spare page was mapped to physical memory page 7 in the mapping table 502 according to FIG. 20, the values of the assembly buffer are actually written to physical memory page 7. Also the content of physical memory page 7 may be double-checked via read back by a high voltage wordline driver path. Moreover, the first logical spare page was mapped to physical memory page 4 again and the content of the first logical spare page was erased. Since the first logical spare page was mapped to physical memory page 4 in the mapping table according to FIG. 21, the content of the first logical spare page was actually erased in physical memory page 4.

Furthermore, FIG. 21 shows, that the MapRAM table was then updated. Thus, i.e., logical memory page 1 was mapped to the physical memory page in the mapping table 502 where the content of logical memory page 1 has been written to, namely physical memory page 7. Moreover, the first logical spare page was mapped to the new free physical memory page in the mapping table, namely physical memory page 4. Finally, the second logical spare page was mapped to the invalid physical memory page in the mapping table, namely physical memory page 1 and marked as invalid.

With respect to the above-described embodiments which relate to the Figures, it is emphasized that the embodiments basically served to increase the comprehensibility. In addition to that, the following further embodiments try to illustrate a more general concept. However, also the following embodiments are not to be taken in a limiting sense.

In this regard, a first embodiment relates to a nonvolatile memory device adapted to use a mapping table to map a set of logical memory element identifiers to a set of corresponding physical memory element identifiers for memory elements of the memory device. Moreover, the memory device is adapted to change a content of a first logical memory element by the following three steps. Firstly, the steps comprises copying a content of a first physical memory element to a second physical memory element according to an identifier of the first logical memory element that maps to an identifier of the first physical memory element and an identifier of a first logical spare memory element that maps to an identifier of the second physical memory element in the mapping table.

Secondly—in case the copying is successful—the steps comprises erasing the content of the first physical memory element. And thirdly—in case the erasing is successful—the steps comprises updating the mapping table so that the identifier of the first logical memory element maps to the identifier of the second physical memory element, and the identifier of the first logical spare memory element maps to the identifier of the first physical memory element.

In one embodiment, the nonvolatile memory—in case the copying the content of the first physical memory element the second physical memory element fails—is further adapted to copy the content of the first physical memory element to a third physical memory element according to an identifier of the first logical memory element that maps to an identifier of the first physical memory element and an identifier of a second logical spare memory element that maps to an identifier of the third physical memory element in the mapping table. In this embodiment, the nonvolatile memory is further adapted to erase the content of the first physical memory element and update the mapping table so that the identifier of the first logical memory element maps to the identifier of the third physical memory element, the identifier of the first logical spare memory element maps to the identifier of the first physical memory element, and the identifier of the second logical spare memory element maps to the identifier of the second physical memory element and designates it as failing.

In a further embodiment, the nonvolatile memory device—in case the erasing the content of the first physical memory element fails—is further adapted to copy the content of the second physical memory element to a third physical memory element according to an identifier of the second logical memory element that maps to an identifier of the second physical memory element and an identifier of a second logical spare memory element that maps to an identifier of the third physical memory element in the mapping table. In this embodiment, the nonvolatile memory is further adapted to erase the content of the second physical memory element and update the mapping table so that the identifier of the first logical memory element maps to the identifier of the third physical memory element, the identifier of the first logical spare memory element maps to the identifier of the second physical memory element, and the identifier of the second logical spare memory element maps to the identifier of the first physical memory element and designates it as failing.

In an embodiment according to previous embodiments, the nonvolatile memory device is further adapted to use at least one high voltage driver also used for programming the memory elements of the memory device to drive—during modified read access—the first physical memory element for reliably detecting if the copying or the erasing the first physical memory element fails by a respective reading current diverging from an expectable reading current.

A further embodiment relates to a nonvolatile memory device adapted to perform an online repair algorithm by detecting (a) failing memory page(s) of the memory device that is/are no longer programmable and/or erasable and mapping identifiers of the failing memory page(s) to identifier(s) of spare memory page(s) in a mapping table.

In an embodiment, the detecting comprises adding marker(s) to content of the memory page(s) to detect and specify if the respective content is valid, and/or use at least one high voltage driver also used for programming the memory page(s) to drive—during modified read access—the memory page(s) for reliably detecting the failing memory page(s) by a respective memory page content diverging from an expectable memory page content.

In an embodiment, the marker(s) comprise(s) additional information about how often the corresponding memory page(s) has/have been programmed and/or erased to yield a common average wear level of the memory page(s) in the online repair algorithm.

A further embodiment relates to a system configured to execute a reliable detection algorithm for defects in a nonvolatile memory device, the system comprising circuits operable to erase at least one memory element of the memory device to provide an expectable reading current in response to a read access to the at least memory element. Moreover, the circuits are operable to determine at least one reading current in response to at least one read access to the at least memory element via at least one access line when driven by at least one driver with predetermined reduced driving capability compared to a standard read driver for read access. Finally, the circuits are operable to determine cases when the at least one reading current diverges from the expectable reading current by more a than predetermined threshold current as defects in the at least one access line or in the at least one memory element itself.

In an embodiment, the detection algorithm is nested into a tearing safe erase algorithm to reliably detect slow and/or non-erasing memory elements.

A further embodiment of the system is configured to decouple the at least one access line or the at least one memory element in which a defect has been determined from a network of usable access lines or memory elements of a nonvolatile memory device to avoid further stress of the at least one defect access line or the at least one defect memory element by programming or erase operations and/or to avoid an overload of charge pumps involved in the corresponding programming or erase operations.

Another embodiment relates to a nonvolatile memory device adapted to use at least one high voltage driver also used for programming memory elements of the memory device to drive—during modified read access—at least one of the memory elements for reliably detecting failing one(s) of the memory elements by a respective reading current diverging from an expectable reading current.

In an embodiment, the memory device is further adapted to nonvolatilely store a redundancy mapping of the failing one(s) of the memory elements to identified redundant memory elements in a second list of redundant memory elements determined during operation of the memory device, wherein the second list supplements or—where applicable—overrides a first list of redundant memory elements determined during production test of the memory device.

In a further embodiment, the memory device is adapted to use the at least one high voltage driver to drive—during modified read access—at least one wordline providing access to at least one predetermined set of the memory elements for reliably detecting an at least partially shorted one of the wordline by a respectively read wordline data content diverging from an expectable wordline data content.

In an embodiment according to the previous embodiments, the second list of redundant memory elements comprises redundant wordlines and/or redundant bitlines arranged in predetermined local proximity to the failing one(s) of the memory elements.

A further embodiment relates to a method for performing a repair algorithm in a nonvolatile memory device during its operation. This method comprises the step of applying a modified erase verify algorithm comprising read accessing at least predetermined one of memory elements of the memory device via at least one driver with predetermined reduced driving capability compared to a driver used for standard read access to reliably detect failing one(s) of the memory elements. Moreover, this embodiment comprises the step of replacing the failing one(s) of the memory elements with a corresponding number of redundant memory elements.

In an embodiment, the repair algorithm is nested into an over-erase type erase algorithm or an adaptive erase algorithm for the nonvolatile memory device.

In an further embodiment, replacing the failing one(s) of the memory elements comprises identifying (a) free one(s) of the redundant memory elements to replace the failing one(s) of the memory elements, and programming a list of identifiers of the identified redundant memory elements to nonvolatile memory elements close to the failing one(s) of the memory elements for mapping the failing one(s) of the memory elements to the identified redundant memory elements during boot of the memory device.

In another embodiment, replacing the failing one(s) of the memory elements comprises nonvolatilely storing a redundancy mapping of the failing one(s) of the memory elements to identified redundant memory elements in a second list of redundant memory elements determined during operation of the memory device, wherein the second list supplements or—where applicable—overrides a first list of redundant memory elements determined during production test of the memory device.

In an embodiment, read accessing the at least predetermined one of memory elements of the memory device via the at least one driver with predetermined reduced driving capability comprises using at least one high voltage driver to drive—during modified read access—at least one wordline providing access to at least one predetermined set of the memory elements for reliably detecting an at least partially shorted one of the wordline by a respectively read wordline data content diverging from an expectable wordline data content.

A further embodiment relates to a method for handling failing memory elements of a nonvolatile memory device comprising using at least one driver with predetermined reduced driving capability compared to a driver used for standard read access to drive—during modified read access—at least one of the memory elements in a reliable detection algorithm for detecting failing one(s) of the memory elements by a respective reading current diverging from an expectable reading current.

In an embodiment, the method further comprises identifying at least one redundant memory element to replace the failing one(s) of the memory elements, nonvolatilely storing a list of addresses of the identified redundant memory elements to nonvolatile memory elements, and replacing the failing one(s) of the memory elements during boot of the memory device by mapping the failing one(s) of the memory elements to the identified redundant memory elements based on the list of addresses.

In an embodiment, the method further comprises identifying (a) failing one(s) of the identified redundant memory elements to replace the failing one(s) of the redundant memory elements by additional one(s) of the identified redundant memory elements based on the detection algorithm, and updating the list of addresses of the identified redundant memory elements accordingly.

In a further embodiment, the detection algorithm is nested into a tearing safe erase algorithm to provide the expectable reading current of erased nonvolatile memory elements.

In a still further embodiment, the detection algorithm is configured to be traced and/or disabled by customer application software for the memory device, preferably adaptively dependent on a predetermined safety level for the memory device.

Another embodiment further comprises decoupling the failing one(s) of the memory elements from a network of usable memory elements of the nonvolatile memory device to avoid further stress of the failing one(s) of the memory elements by programming or erase operations and/or to avoid an overload of charge pumps involved in the corresponding programming or erase operations.

A further embodiment relates to a nonvolatile memory device adapted to perform a repair algorithm during operation of the memory device, the memory device comprising circuits operable to apply a modified erase verify algorithm wherein a verify step of the modified erase verify algorithm comprises a read access to at least one predetermined one of memory elements of the memory device via at least one driver with predetermined reduced driving capability compared to a driver used for standard read access to reliably detect failing one(s) of the memory elements, and replace the failing one(s) of the memory elements with a corresponding number of redundant memory elements.

In an embodiment, the repair algorithm is nested into an over-erase type erase algorithm or an adaptive erase algorithm for the nonvolatile memory device.

In an embodiment, the configuration of the memory device to replace the failing one(s) of its memory elements comprises that the circuits are further operable to identify (a) free one(s) of the redundant memory elements to replace the failing one(s) of the memory elements, and program a list of identifiers of the identified redundant memory elements to nonvolatile memory elements close to the failing one(s) of the memory elements for mapping the failing one(s) of the memory elements to the identified redundant memory elements during boot of the memory device.

In a further embodiment, the configuration of the memory device to replace the failing one(s) of its memory elements comprises that the circuits are further operable to identify (a) failing one(s) of the redundant memory elements to replace the failing one(s) of the redundant memory elements by additional one(s) of the identified redundant memory elements based on the modified erase verify algorithm, and update the programmed list of identifiers of the identified redundant memory elements accordingly.

In a still further embodiment, the predetermined reduced driving capability of the at least one driver compared to a driver used for normal read access is adapted to reliably detect at least one at least partially shorted wordline providing access to the failing one(s) of the memory elements.

In another embodiment, the at least one driver with predetermined reduced driving capability comprises at least one re-used high voltage driver primarily used for programming the memory device.

In an embodiment, the repair algorithm is configured to be traced and/or disabled by customer application software for the memory device, preferably adaptively dependent on a predetermined safety level of the memory device.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A nonvolatile memory device adapted to:
use a mapping table to map a set of logical memory element identifiers to a set of corresponding physical memory element identifiers for memory elements of the memory device;
change a content of a first logical memory element by:
copying a content of a first physical memory element to a second physical memory element according to an identifier of the first logical memory element that maps to an identifier of the first physical memory element and an identifier of a first logical spare memory element that maps to an identifier of the second physical memory element in the mapping table;
on the copying being successful, erasing the content of the first physical memory element; and
on the erasing being successful, updating the mapping table so that the identifier of the first logical memory element maps to the identifier of the second physical memory element, and the identifier of the first logical spare memory element maps to the identifier of the first physical memory element.

2. The nonvolatile memory device of claim 1, wherein on the copying the content of the first physical memory element the second physical memory element failing, the nonvolatile memory device being further adapted to:
copy the content of the first physical memory element to a third physical memory element according to an identifier of the first logical memory element that maps to an identifier of the first physical memory element and an identifier of a second logical spare memory element that maps to an identifier of the third physical memory element in the mapping table;
erase the content of the first physical memory element; and
update the mapping table so that the identifier of the first logical memory element maps to the identifier of the third physical memory element, the identifier of the first logical spare memory element maps to the identifier of the first physical memory element, and the identifier of the second logical spare memory element maps to the identifier of the second physical memory element and designate it as failing.

3. The nonvolatile memory device of claim 1, wherein on the erasing the content of the first physical memory element failing, the nonvolatile memory device being further adapted to:
copy the content of the second physical memory element to a third physical memory element according to an identifier of the second logical memory element that maps to an identifier of the second physical memory element and an identifier of a second logical spare memory element that maps to an identifier of the third physical memory element in the mapping table;
erase the content of the second physical memory element; and
update the mapping table so that the identifier of the first logical memory element maps to the identifier of the third physical memory element, the identifier of the first logical spare memory element maps to the identifier of the second physical memory element, and the identifier of the second logical spare memory element maps to the identifier of the first physical memory element and designates it as failing.

4. The nonvolatile memory device of claim 2, further adapted to:
use at least one high voltage driver, also used for programming the memory elements of the memory device, to drive, during modified read access, the first physical memory element for reliably detecting if the copying or the erasing the first physical memory element fails by a respective reading current diverging from an expectable reading current.

5. A nonvolatile memory device adapted to:
perform an online repair algorithm by:
detecting one or more failing memory pages of the memory device that are no longer programmable and/or erasable; and
mapping identifiers of the failing memory pages to one or more identifiers of spare memory pages in a mapping table.

6. The nonvolatile memory device of claim 5, wherein the detecting comprises:
adding marker(s) to content of the memory page(s) to detect and specify if the respective content is valid; and/or
use at least one high voltage driver also used for programming the memory page(s) to drive, during modified read access, the memory page(s) for reliably detecting the failing memory page(s) by a respective memory page content diverging from an expectable memory page content.

7. The nonvolatile memory device of claim 6, wherein the marker(s) comprise(s) additional information about how often the corresponding memory page(s) has/have been programmed and/or erased to yield a common average wear level of the memory page(s) in the online repair algorithm.

8. A system configured to execute a reliable detection algorithm for defects in a nonvolatile memory device, the system comprising circuits adapted to:
erase at least one memory element of the memory device to provide an expectable reading current in response to a read access to the at least one memory element;
determine at least one reading current in response to at least one read access to the at least one memory element via at least one access line when driven by at least one driver with predetermined reduced driving capability compared to a standard read driver for read access; and
determine cases when the at least one reading current diverges from the expectable reading current by more than a predetermined threshold current as defects in the at least one access line or in the at least one memory element itself.

9. The system of claim 8, wherein the detection algorithm is nested into a tearing safe erase algorithm to reliably detect slow and/or non-erasing memory elements.

10. The system of claim 8, configured to decouple the at least one access line or the at least one memory element in which a defect has been determined from a network of usable access lines or memory elements of a nonvolatile memory device to avoid further stress of the at least one defect access line or the at least one defect memory element by programming or erase operations and/or to avoid an overload of charge pumps involved in the corresponding programming or erase operations.

11. A nonvolatile memory device adapted to:
use at least one high voltage driver, also used for programming memory elements of the memory device, to drive, during modified read access, at least one of the memory elements for reliably detecting failing one(s) of the memory elements by a respective reading current diverging from an expectable reading current.

12. The memory device of claim 11, further adapted to nonvolatilely store a redundancy mapping of the failing one(s) of the memory elements to identified redundant memory elements in a second list of redundant memory elements determined during operation of the memory device, wherein the second list supplements or overrides a first list of redundant memory elements determined during production test of the memory device.

13. The memory device of claim 11, further adapted to use the at least one high voltage driver to drive, during a modified read access, at least one wordline providing access to at least one predetermined set of the memory elements for reliably detecting an at least partially shorted one of the wordline by a respectively read wordline data content diverging from an expectable wordline data content.

14. The memory device of claim 12, wherein the second list of redundant memory elements comprises redundant wordlines and/or redundant bitlines arranged in predetermined local proximity to the failing one(s) of the memory elements.

15. A method for performing a repair algorithm in a nonvolatile memory device during its operation, the method comprising:
applying a modified erase verify algorithm comprising read accessing at least predetermined one of memory elements of the memory device via at least one driver with predetermined reduced driving capability compared to a driver used for standard read access to reliably detect one or more failing memory elements; and
replacing the failing memory elements with a corresponding number of redundant memory elements.

16. The method of claim 15, wherein the repair algorithm is nested into an over-erase type erase algorithm or an adaptive erase algorithm for the nonvolatile memory device.

17. The method of claim 15, wherein replacing the failing memory elements comprises:
identifying one or more redundant memory elements to replace the failing memory elements; and
programming a list of identifiers of the identified redundant memory elements to nonvolatile memory elements close to the failing memory elements for mapping the failing memory elements to the identified redundant memory elements during boot of the memory device.

18. The method of claim 15, wherein replacing the failing memory elements comprises:
nonvolatilely storing a redundancy mapping of the failing memory elements to identified redundant memory elements in a second list of redundant memory elements determined during operation of the memory device, wherein the second list supplements or overrides a first list of redundant memory elements determined during production test of the memory device.

19. The method of claim 15, wherein read accessing the at least predetermined one of memory elements of the memory device via the at least one driver with predetermined reduced driving capability comprises:
using at least one high voltage driver to drive, during modified read access, at least one wordline providing access to at least one predetermined set of the memory elements for reliably detecting an at least partially shorted one of the wordline by a respectively read wordline data content diverging from an expectable wordline data content.

20. A method for handling failing memory elements of a nonvolatile memory device comprising:
using at least one driver with predetermined reduced driving capability to drive, during modified read access, at least one of the memory elements in a reliable detection algorithm for detecting one or more failing memory elements by a respective reading current diverging from an expectable reading current.

21. The method of claim 20, further comprising:
identifying at least one redundant memory element to replace the failing memory elements;
nonvolatilely storing a list of addresses of the identified redundant memory elements to nonvolatile memory elements; and
replacing the failing memory elements during boot of the memory device by mapping the failing memory elements to the identified redundant memory elements based on the list of addresses.

22. The method of claim 21, further comprising
identifying one or more failing redundant memory elements of the identified redundant memory elements to replace the failing redundant memory elements by one or more additional identified redundant memory elements of the identified redundant memory elements based on the detection algorithm; and
updating the list of addresses of the identified redundant memory elements accordingly.

23. The method of claim 20, wherein the detection algorithm is nested into a tearing safe erase algorithm to provide the expectable reading current of erased nonvolatile memory elements.

24. The method of claim 20, wherein the detection algorithm is configured to be traced and/or disabled by customer application software for the memory device, adaptively dependent on a predetermined safety level for the memory device.

25. The method of claim 20, further comprising:
decoupling the failing memory elements from a network of usable memory elements of the nonvolatile memory device to avoid further stress of the failing memory elements by programming or erase operations and/or to avoid an overload of charge pumps involved in the corresponding programming or erase operations.
